(19) United States
(12) Patent Application Publication
(10) Pub. No.: US 2024/0257394 A1
(43) Pub. Date: Aug. 1, 2024

(54) METHOD, SYSTEM AND COMPUTER READABLE MEDIUM FOR CALIBRATION OF COOPERATIVE SENSORS

(71) Applicant: Curium Pte. Ltd., Singapore (SG)

(72) Inventors: Ali Hasnain, Singapore (SG); Kutluhan Buyukburc, Singapore (SG); Pradeep Anand Ravindranath, Singapore (SG)

(21) Appl. No.: 18/040,181

(22) PCT Filed: Jul. 30, 2021
(86) PCT No.: PCT/SG2021/050444

§ 371 Date: Feb. 1, 2023

(30) Foreign Application Priority Data
Aug. 1, 2020 (SG) 10202007357Y

(51) Int. Cl. G06T 7/80; G06T 7/70; G06V 10/26; G06V 10/762

(52) U.S. Cl. CPC G06T 7/80; G06T 7/70; G06V 10/26; G06V 10/762; G06T 2207/10028

(57) ABSTRACT

The present application provides methods, systems and computer readable media for calibration of cooperative sensors. In an embodiment, there is provided a method for calibration of cooperative sensors. The method comprises: obtaining a first set of sensor data for an environment from a first sensor; obtaining a second set of sensor data for the environment from a second sensor that is cooperative with the first sensor; identifying one or more objects from the first set of sensor data and the second set of sensor data; generating a first point cloud data (PCD) representation for the one or more objects identified from the first set of sensor data; generating a second point cloud data (PCD) representation for the one or more objects identified from the second set of sensor data; identifying one or more common objects that are present in both the first PCD representation and the second PCD representation; identifying feature point pairs for each object in the one or more common objects, wherein each feature point pair of the feature point pairs comprises one or more feature points extracted from the first PCD representation and/or the second PCD representation corresponding to a same or similar feature of the object; and for each feature point pair of the feature point pairs, minimizing a distance between feature points in the feature point pair so as to form an extrinsic calibration matrix for calibrating the second sensor based on the first sensor.

### TECHNICAL FIELD

The present specification relates broadly, but not exclusively, to methods, systems, and computer readable media for calibration of cooperative sensors.

### BACKGROUND

Calibration refers to a process of correcting systematic errors by comparing a sensor response with ground truth values or with another calibrated sensor. In complicated systems involving large-scale networks, the challenges are multifactorial, as there is a need to calibrate a large number of sensors and the inconvenience of physically accessing the sensor and calibrating them manually especially those which are deployed in remote inaccessible areas. Mis-calibration of sensors (noise, sensor failure, drift, reading bias or precision and sensitivity degradation) after deployment in a system is a common problem which could be due to environmental factors such as temperature variations, moisture, vibrations, exposure to sun etc.

In critical multi-sensory systems, continuous monitoring of sensors to ensure proper calibration is often required. Continuous calibration of sensors has become highly essential for semi- and fully autonomous vehicles (AVs). As we move towards self-driven cars, any tolerance towards sensor errors should be minimized. Without properly calibrated sensors, the decision-making module leads to poor decisions. Sensor calibration refers to both intrinsic (i.e., focal length in cameras, bias in LiDAR measurements etc.) and extrinsic (i.e., position and orientation (pose) with respect to the world frame or any other sensor frame). Intrinsic parameters are usually calibrated by the manufacturer and do not change as they are not impacted by the outside world. If the intrinsic calibration parameters are not known, they can be acquired by performing known conventional calibration techniques (Computer Vision-based). It is safe to assume that the intrinsic calibration parameters stay the same unless there is a forced damage to the sensor. However, the extrinsic calibration parameters are quite susceptible to environmental changes such as temperature, vibrations etc. and may change over time especially for systems which are operated in harsh indoor or outdoor environments.

Not only are the traditional methods being widely used, they bring in excessive reliance upon human experts and are very time consuming. Therefore, calibration is a central piece in achieving autonomy in AVs or other intelligent systems. As an example, for an object at a distance of 100 meters from the AV, a calibration accuracy of ˜0.2 degree in rotation is needed to reliably fuse measurements from multiple sensors. That is why calibration is critical for AVs to be functionally reliable.

Conventional calibration methods are manual and cumbersome. They often require specific physical targets to calibrate. Such methods limit its practical use, as often times it is impractical to place targets within the sensor environment. There have been target-less methods described in the literature but they work in a controlled environment, or sometime may not be practically feasible.

A need therefore exists to provide methods and devices that seek to overcome or at least minimize the above-mentioned problems so as to provide an enhanced target-less approach for calibration of cooperative sensors that can be used both indoors and outdoors.

### SUMMARY

According to an embodiment, there is provided a method for calibration of cooperative sensors, the method comprising: obtaining a first set of sensor data for an environment from a first sensor; obtaining a second set of sensor data for the environment from a second sensor that is cooperative with the first sensor; identifying one or more objects from the first set of sensor data and the second set of sensor data; generating a first point cloud data (PCD) representation for the one or more objects identified from the first set of sensor data; generating a second point cloud data (PCD) representation for the one or more objects identified from the second set of sensor data; identifying one or more common objects that are present in both the first PCD representation and the second PCD representation; identifying feature point pairs for each object in the one or more common objects, wherein each feature point pair of the feature point pairs comprises one or more feature points extracted from the first PCD representation and/or the second PCD representation corresponding to a same or similar feature of the object; and for each feature point pair of the feature point pairs, minimizing a distance between feature points in the feature point pair so as to form an extrinsic calibration matrix for calibrating the second sensor based on the first sensor.

According to another embodiment, there is provided a system for calibration of cooperative sensors, the system comprising: at least one processor; and a memory including computer program code for execution by the at least one processor, the computer program code instructs the at least one processor to: obtain a first set of sensor data for an environment from a first sensor; obtain a second set of sensor data for the environment from a second sensor that is cooperative with the first sensor; identify one or more objects from the first set of sensor data and the second set of sensor data; generate a first point cloud data (PCD) representation for the one or more objects identified from the first set of sensor data; generate a second point cloud data (PCD) representation for the one or more objects identified from the second set of sensor data; identify one or more common objects that are present in both the first PCD representation and the second PCD representation; identify feature point pairs for each object in the one or more common objects, wherein each feature point pair of the feature point pairs comprises one or more feature points extracted from the first PCD representation and/or the second PCD representation corresponding to a same or similar feature of the object; and for each feature point pair of the feature point pairs, minimize a distance between feature points in the feature point pair so as to form an extrinsic calibration matrix for calibrating the second sensor based on the first sensor.

According to yet another embodiment, there is provided a non-transitory computer readable storage medium having instructions encoded thereon that, when executed by a processor, cause the processor to: obtain a first set of sensor data for an environment from a first sensor; obtain a second set of sensor data for the environment from a second sensor that is cooperative with the first sensor; identify one or more objects from the first set of sensor data and the second set of sensor data; generate a first point cloud data (PCD) representation for the one or more objects identified from the first set of sensor data; generate a second point cloud data (PCD) representation for the one or more objects identified from the second set of sensor data; identify one or more common objects that are present in both the first PCD representation and the second PCD representation; identify feature point pairs for each object in the one or more common objects, wherein each feature point pair of the feature point pairs comprises one or more feature points extracted from the first PCD representation and/or the second PCD representation corresponding to a same or similar feature of the object; and for each feature point pair of the feature point pairs, minimize a distance between feature points in the feature point pair so as to form an extrinsic calibration matrix for calibrating the second sensor based on the first sensor.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1A shows a simplistic representation of a methodology of the present application.

FIG. 1B is a flow chart illustrating a method for calibration of cooperative sensors according to an embodiment.

FIG. 2 is a general process flow of calibrating one sensor from the other.

FIG. 3 is a more detailed version of process described in FIG. 1A in accordance with an embodiment.

FIG. 4 is a variation of the method described in FIG. 3 for performing calibration without the need of prior sensor pose data.

FIG. 5 shows a process flow for a particular use case of calibrating a LIDAR sensor from a camera or stereo-camera sensor.

FIG. 6 shows a process flow for a particular use case of calibrating a camera or stereo-cameras or images from a LIDAR sensor.

FIG. 7 shows a process flow for a particular use case of calibrating a camera or stereo-camera sensor from another camera or stereo-camera sensor.

FIG. 8 shows two consecutive camera frames (Camera0: frames 18 & 19) of publicly available KITTI dataset.

FIG. 9 shows visualization results of LiDAR frames feature points.

FIG. 10 shows curves of LiDAR calibration with respect to each rotation axis of the AV frame.

FIG. 11 shows results of LiDAR to camera frames feature points.

FIG. 12 shows results of Camera to LiDAR frames feature points.

FIG. 13 shows results of Camera to Camera frames feature points.

FIG. 14 shows a screenshot of results from in an outdoor residential neighbourhood with before and after calibration for a particular use case of calibrating a LiDAR sensor from a Stereo Camera.

FIG. 15 shows a process flow for a particular use case of calibrating a LIDAR sensor from an RGB-D Camera.

FIG. 16 shows a process flow for a particular use case of calibrating an RGB-D Camera sensor from a LiDAR.

FIG. 17 shows a process flow for a particular use case of calibrating one RGB-D Camera from another RGB-D Camera.

FIG. 18a shows the RGB-D cameras setup. FIG. 18b shows the target-based calibration using intel stereo cameras (D435i) and checkerboard to obtain Ground Truth (GT) for validation purposes only.

FIG. 19a shows the 3D point clouds captured using two Intel RealSense D435i (uncalibrated). FIG. 19b shows with ground truth calibration (18b) and FIG. 19c shows results with our approach.

FIG. 20a shows a screenshot of results from an indoor miniaturised vehicle setup. FIG. 20b shows visualisation results based on real cars in a parking lot (static objects). FIG. 20c shows multiple static and dynamic objects such as vehicles, motorbikes and pedestrians.

FIG. 21 shows a process flow for a particular use case of calibrating a Radar sensor from a LIDAR sensor.

FIG. 22a shows the LiDAR (green) and RADAR (red) with ground truth calibration applied. FIG. 22b shows the falsified RADAR PCD superimposed on LiDAR data. FIG. 22c shows after our calibration method applied only optimizing the rotation and with prior translation applied.

FIG. 23 shows a process flow for a particular use case of calibrating a Radar sensor from a monocular Camera sensor.

FIG. 24 shows a process flow for a particular use case of calibrating a Radar sensor from a Camera sensor with depth information.

FIG. 25(a-d) shows the RADAR object detection and segmentation. FIG. 25(e-f) shows the image and mask segmentation of the object (car).

FIG. 26a shows the RADAR object detection. FIG. 26b shows the image with the centroid of the car. FIG. 26c shows the calibrated result of RADAR object centroid with the Camera.

FIG. 27 shows a block diagram of a computer system 2700 for calibration of cooperative sensors as exemplified in FIG. 1B.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “generating”, “minimizing”, “projecting”, “calibrating”, “transforming”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer or may include multiple computing devices and/or cloud-based devices. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the specification contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

This specification uses the term “configured to” in connection with systems, devices, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

Embodiments of the present application provide approaches that leverage on the use of Point Cloud Data (PCD) generated by the sensor response such as from a camera, LiDAR (Light Detection and Ranging), RADAR (Radio Detection and Ranging), Ultrasonic sensors, proximity or distance sensors or any range sensor capable of generating a PCD of the objects in a given environment. The present application leverages on generation of PCD from the sensor output either directly or indirectly through performing another step. For example, LiDAR generates PCD directly through laser scanning whereas it can also be generated using 2D or 3D images, stereo-images or depth data. The present application starts by making sure that all the sensors are intrinsically calibrated and intrinsic calibration parameters are known, either given by the manufacturer or by performing an intrinsic calibration procedure. The present application performs extrinsic calibration of a sensor or a set of sensors under consideration using another sensor or a set of sensors which is or are calibrated. The present application is based on a target-less calibration approach which looks for useful features and correspondences in any kind of environment, as long as they are perceived by the sensors. Such features can come from static objects such as lane marking, kerbs, pillars, lamp posts, trees, buildings and any other stationary objects with respect to its surroundings and dynamic objects such as vehicles, pedestrians and any other objects that can change its position with respect to its surroundings. Such dynamic objects may also be moving during the calibration of multiple sensors.

Further, the present application generates PCD from the sensor output even if the output of the sensor is not in the PCD form such as in LiDAR as opposed to stereo-camera images which can be converted to a PCD through intermediate processing step(s) using existing or custom approaches.

Equations 1, 2 give relations for the calibration matrix of sensor1 to sensor2 reference, its optimisation and cost function. Equation 3 represents the point cloud data of points in the world frame.

$${C}_{sensor 2}^{sensor 1} = ( \begin{matrix}{R}_{sensor 2}^{sensor 1} & {T}_{sensor 2}^{sensor 1} \\ 0 & 1\end{matrix} ) \qquad ( 1 )$$

$$\{ {M}_{t 1} {C}_{sensor 2}^{sensor 1} {X}_{t 1}^{sensor 1} \vert t ∈ \{ 1 , … , N \} \} = \{ {M}_{t 2} {X}_{t w}^{sensor 2} \vert t ∈ \{ 1 , … , N \} \} \qquad ( 2 )$$

$$P = \{ {X}_{t}^{w} \vert t ∈ \{ 1 , … , N \} \} \qquad ( 3 )$$

where,
C=Calibration matrix
Mt=Pose at time t (Sensor2; t=t1 and t=t2)
Xₜ=Point in Cartesian space at time t
R=Rotation matrix
T=Translation vector
N=Number of times steps or poses
P=Point Cloud, PCD
t=time
t1 and t2=time; t1 and t2 could be different or same
w=World frame

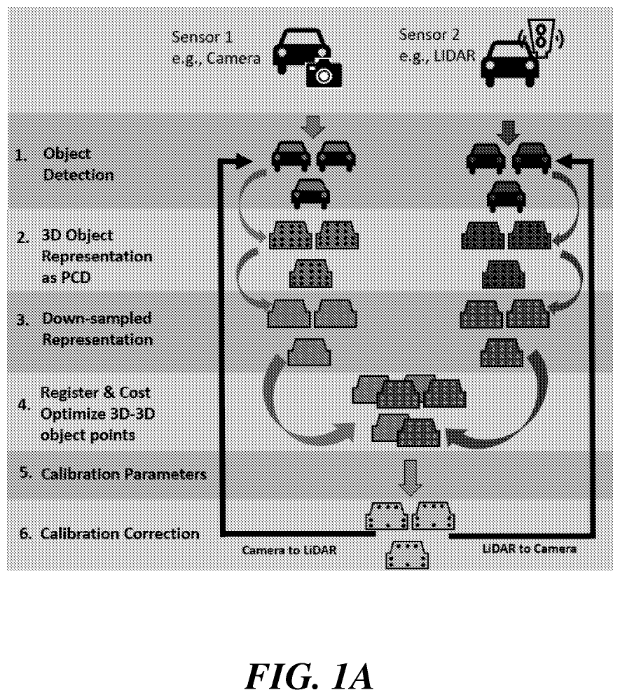

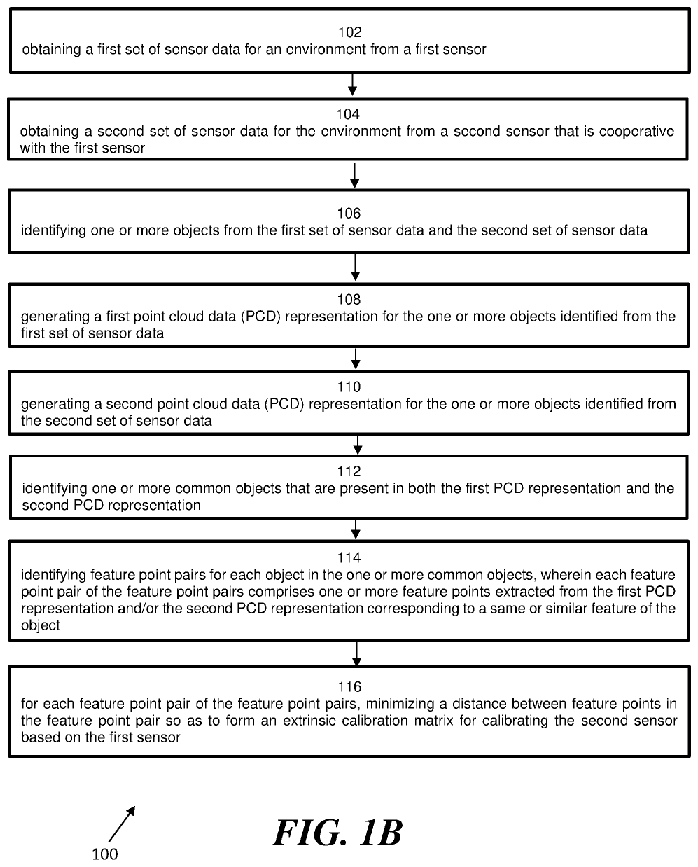

FIG. 1A provides the overview of the general methodology. Different sensors may come with their own processing steps as detailed in the embodiments. The first step in the procedure includes point cloud data generation from sensors. While it may be straight-forward for sensors such as LiDAR, for sensors such as cameras the 3D PCD is obtained using depth information from the monocular camera, depth camera or obtained using stereo images. The next step is to detect objects from the respective sensor frames. There can be two different approaches for object detection, but not limited to:
1. In the case of raw PCD from sensors, the present application uses algorithms that can detect objects directly from the PCD, and
2. In the case where the PCD is derived, e.g., from stereo cameras, the present application detects the objects in their original representation and extract the objects as a 3D representation.

After the object is identified or detected, the identified or detected object is extracted from the frame through a segmentation process/step that includes either extracting the geometry of the object or creating a bounding box around it. Following the object detection and segmentation, the present application proceeds with registering the points from the mis-calibrated sensor to the reference sensor. Then the Iterative Closest Point (ICP) algorithm is used to get the point pairs, followed by cost optimization of the point pairs to obtain the best alignment. The resulting calibration matrix is then used to correct the mis-calibrated sensor. The steps can be performed in any order in part or full using different computational resources such as computer, Cloud and/or embedded systems. In addition, the steps can be performed in any order in part or full on either one processor or multiple processors.

FIG. 1B shows a flow chart illustrating a method 100 for calibration of cooperative sensors according to an embodiment.

As shown in FIG. 1B, in step 102, the embodiment of method 100 includes obtaining a first set of sensor data for an environment from a first sensor.

In step 104, the embodiment of method 100 includes obtaining a second set of sensor data for the environment from a second sensor that is cooperative with the first sensor.

In step 106, the embodiment of method 100 includes identifying one or more objects from the first set of sensor data and the second set of sensor data.

In step 108, the embodiment of method 100 includes generating a first point cloud data (PCD) representation for the one or more objects identified from the first set of sensor data.

In step 110, the embodiment of method 100 includes generating a second point cloud data (PCD) representation for the one or more objects identified from the second set of sensor data.

In step 112, the embodiment of method 100 includes identifying one or more common objects that are present in both the first PCD representation and the second PCD representation.

In step 114, the embodiment of method 100 includes identifying feature point pairs for each object in the one or more common objects, wherein each feature point pair of the feature point pairs comprises one or more feature points extracted from the first PCD representation and/or the second PCD representation corresponding to a same or similar feature of the object.

In step 116, the embodiment of method 100 includes for each feature point pair of the feature point pairs, minimizing a distance between feature points in the feature point pair so as to form an extrinsic calibration matrix for calibrating the second sensor based on the first sensor.

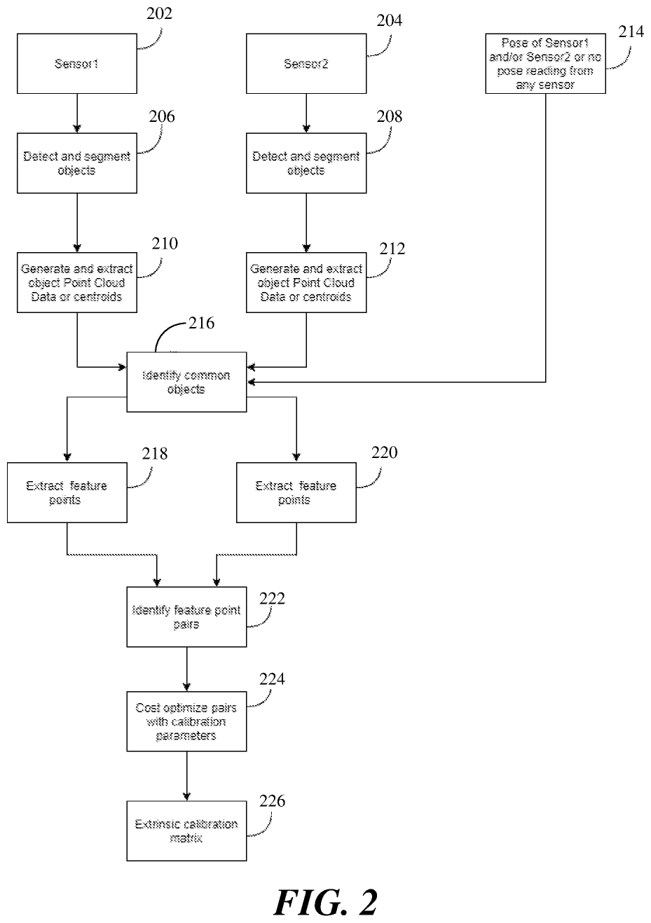

FIG. 2 describes a general layout of the process flow to determine new extrinsic calibration parameter of uncalibrated or mis-calibrated Sensor1 from calibrated Sensor2. 202 and 204 are sensor data from Sensor1 and Sensor 2 respectively. The objects are detected and segmented 206 and 208 from the sensor data 202 and 204. The segmented objects are then converted into centroid or PCDs 210 and 212. From the two sets of centroids or object PCDs, the common objects are identified with the pose data of Sensor1 and/or Sensor2 or in case of absence of pose data 214 the common objects can be identified independently using prior knowledge of the objects and/or applying a coarse sensor fusion to identify the common field of view. Following which the feature points 218, 220 are identified and extracted from the PCD 210, 212 of every object of interest. After the feature points 218 and 220 from PCDs of both sensors 202 and 204 are determined, a procedure of identifying feature point pairs 222 for all the identified common objects 216 and/or extracted feature points of the common objects 218, 220 is performed. Once the pairs 222 are identified the distance between the feature point pairs 222 is minimized through cost optimisation of points 224 from the same or similar features in two PCDs. This determines the extrinsic calibration matrix 226 for Sensor1 with respect to Sensor2, even without the knowledge of the initial extrinsic calibration parameters of Sensor1.

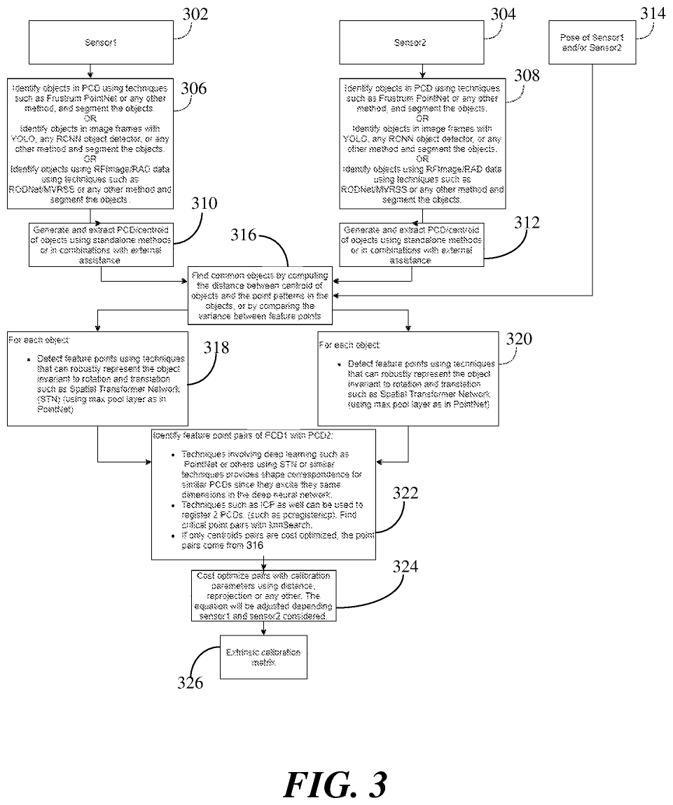

FIG. 3 describes a detailed layout of the process flow explained in FIG. 2 to determine the extrinsic calibration parameters of uncalibrated or mis-calibrated Sensor1 from calibrated Sensor2 along with possible variations in the process. 302 and 304 are respective sensor data from Sensor1 and Sensor2.

In one embodiment, the objects of interest can be directly identified and segmented 306, 308 from sensor output PCD by using approaches such as Frustrum PointNet, OpenPCDet, but not limited to, or other similar deep learning-based or any other approaches.

In another embodiment, the objects of interest can be identified and segmented 306, 308 from the sensor output, such as camera images, using approaches such as YOLO, ResNet, maskR-CNN but not limited to, or any deep learning-based approaches or any other approaches.

In another embodiment, the objects of interest can be identified and segmented 306, 308 from sensor output, such as RFImage or RAD data, using approaches such as RODNet or MVRSS but not limited to, or any deep learning-based approaches or any other approaches.

After identifying and segmenting the objects of interest, the method generates and extracts PCD or centroids 310, 312 of the objects from 306, 308.

In another embodiment, the common objects 316 between the two sensors' generated or derived object PCDs or centroids 310, 312 can be identified with the pose data for Sensor1 and/or Sensor2 314 by computing the distance between the centroids, analysing the point patterns in the identified objects 306, 308, and comparing the variance between the identified feature points or by applying point registering techniques such as Iterative Closest Point (ICP), but not limited to, or any method that uses nearest neighbour search (KNN, density-based clustering) or any other method can be used to find point pairs.

By feeding the PCD 316 into the model to retrieve the feature points 318, 320 that represent the object's global features. The PCDs are made invariant to geometric transformations by using established techniques such as Spatial Transformer Network (STN) or any variations of the technique, but not limited to, or any such approach. Step 318, 320 is performed for every object. After the feature points 318, 320 from object PCDs 310, 312 of both sensors are determined, procedures for identifying feature point pairs 322 for all the identified common objects 316 are performed.

In one embodiment, deep learning techniques such as PointNet or STN-based approaches, or similar techniques, but not limited to, or any method which provides shape correspondence for similar PCDs since they excite the same dimensions, or point registering techniques such as Iterative Closest Point (ICP), but not limited to, or any method that uses nearest neighbour search (KNN, density-based clustering) or any other method can be used to find feature pairs. In addition, coarse sensor fusion may be applied to identify common objects as well. In case of only object centroids of the segmented objects are used for cost optimization, the common object centroid pairs 316 can be used to perform cost optimization.

Once the pairs 322 are identified the distance between the pairs or any other cost functions 324 are minimized optimizing the calibration parameters. The result of this cost optimisation of points 324 from the same or similar features in two PCDs determines the extrinsic calibration matrix 326, for Sensor1 with respect to Sensor2 even without the knowledge of the initial extrinsic calibration parameters of Sensor1.

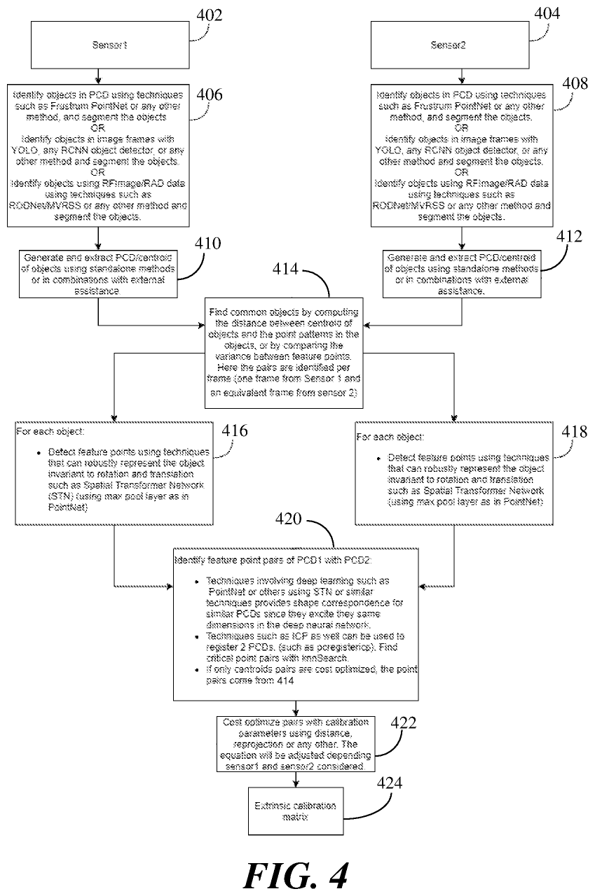

FIG. 4 describes a variation of the detailed layout of the process flow explained in FIG. 2 to determine the extrinsic calibration parameters of uncalibrated or mis-calibrated Sensor1 from calibrated Sensor2 along with possible variations in the process. 402 and 404 are respective sensor data from Sensor1 and Sensor2.

In one embodiment, the objects of interest can be directly identified and segmented 406, 408 from sensor output PCD by using approaches such as Frustrum PointNet, OpenPCDet, but not limited to, or other similar deep learning-based or any other approaches.

In another embodiment, the objects of interest can be identified and segmented 406, 408 from the sensor output, such as camera images, using approaches such as YOLO, ResNet, maskR-CNN but not limited to, or any deep learning-based approaches or any other approaches.

In another embodiment, the objects of interest can be identified and segmented 406, 408 from sensor output, such as RFImage or RAD data, using approaches such as RODNet or MVRSS but not limited to, or any deep learning-based approaches or any other approaches.

After identifying and segmenting the objects of interest, the method generates and extracts PCD or centroids 410, 412 of the objects from 406, 408.

In another embodiment, the common objects 414 between the two sensors' are identified per frame (one frame from Sensor1 and an equivalent frame from Sensor2). This step eliminates the requirement of the pose data of Sensor1 and/or Sensor2 as the calibration will be done considering the Sensor1 object points in Sensor1 coordinate system and Sensor2 object points in Sensor2 coordinate system, instead of transforming both points in the world coordinate system.

By feeding the PCD 414 into the model to retrieve the feature points 416, 418 that represent the object's global features. The PCDs are made invariant to geometric transformations by using established techniques such as Spatial Transformer Network (STN) or any variations of the technique, but not limited to, or any such approach. Step 416, 418 is performed for every object. After the feature points 416, 418 from object PCDs 410, 412 of both sensors are determined, procedures for identifying feature point pairs 420 for all the identified common objects 414 are performed.

In one embodiment, deep learning techniques such as PointNet or STN-based approaches, or similar techniques, but not limited to, or any method which provides shape correspondence for similar PCDs since they excite the same dimensions, or point registering techniques such as Iterative Closest Point (ICP), but not limited to, or any method that uses nearest neighbour search or any other method can be used to find feature pairs. In addition, coarse sensor fusion may be applied to identify common objects as well. In case only centroids are used for cost optimization, the common object centroid pairs 414 can be used to perform cost optimization.

Once the pairs 420 are identified the distance between the pairs or any other cost functions 422 are minimized optimizing the calibration parameters. The result of this cost optimisation of points 422 from the same or similar features in two PCDs 410, 412 determines the extrinsic calibration matrix 424, for Sensor1 with respect to Sensor2 even without the knowledge of the initial extrinsic calibration parameters of Sensor1.

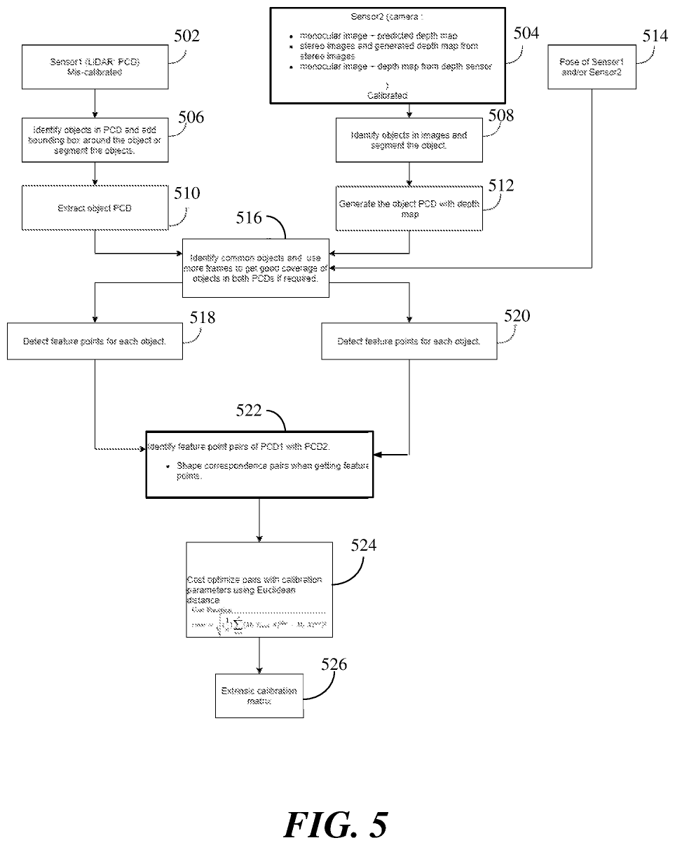

In one system/embodiment, a LiDAR sensor is calibrated using a camera sensor as shown in FIG. 5. For demonstration purposes publicly available KITTI dataset for LIDAR and stereo-cameras mounted on top of an AV is used. 502 and 504 generate sensor output. The LiDAR 502 is required calibrated with the Stereo/monocular/RGB-D camera 504. The PCD from 502 is used to identify objects of interest, and the objects are segmented, or a bounding box placed around them 506. Then the object PCDs are extracted 510. The objects of interest are identified using the camera image (one of the images in case of stereo images) 504 and segmented 508. The object PCDs 512 are then generated using the camera image (one of the images in case of stereo images) and depth map constructed from the stereo image or predicted using deep learning models or using depth sensor or any other method. One or more common objects 516 are identified with the pose data for LiDAR and/or Camera 514 in the object PCDs using one or more frames of the sensors. Following which, the feature points 518, 520 are identified using the deep learning techniques such as PointNet, or STN-based approaches, but not limited to any similar techniques or any other approaches to generate the feature points that includes down-sampling methods.

In one embodiment, the feature point extraction method can be used for feature point pairing from two PCDs in the same order the features corresponding to shapes were learnt by the trained deep learning-based model.

In another embodiment, method such as Iterative Closest Point (ICP), but not limited to, or neighbourhood search (KNN, density-based clustering) or any such method to register feature point pairs. Once the pairs 522 are identified the distance between the pairs is minimized by optimizing the calibration parameters 524. The result of this cost optimisation of points 524 that corresponds to the same or similar features in two PCDs determines the extrinsic calibration matrix 526 for Sensor1 with respect to Sensor2, even without the knowledge of the initial extrinsic calibration parameters of Sensor1.

Equations 7, 8, 9 give relations for the calibration matrix of Lidar to Camera reference, its optimisation and cost function.

In one embodiment, if LiDAR axes are not oriented to the AV reference or Inertial Measurement Unit (IMU), an intermediate step(s) can be performed to first align the axes before proceeding to the method described in FIG. 2. This provides an initial starting point for the ICP point registration algorithm. If the feature points and the feature pairs are obtained directly from the deep learning based-architecture, this operation is not needed since the feature pairs are already obtained as part of the shape correspondence provided by the deep learning-based method. The result of the LiDAR to Camera or Camera to LIDAR can be feed iteratively into the ICP technique to improve the calibration results. Equations 4, 5, 6 give relations for the calibration matrix of Lidar to AV reference, its optimisation and cost function.

$$\begin{matrix}LIDAR TO AV REFERENCE & \\ {C}^{Lidar} = ( \begin{matrix}{R}^{Lidar} & {T}^{Lidar} \\ 0 & 1\end{matrix} ) & ( 4 )\end{matrix}$$

$$\begin{matrix}Optimization & \\ \{ {M}_{t} {C}^{Lidar} {X}_{t}^{Lidar} \vert t ∈ \{ 1 , … , N \} \} = \{ {M}_{t + 1} {C}^{Lidar} {X}_{t + 1}^{Lidar} \vert t ∈ \{ 1 , … , N \} \} & ( 5 )\end{matrix}$$

$$\begin{matrix}Cost Function & \\ rmse = \sqrt{( \frac{1}{n} ) {\sum }_{1}^{n} {( {M}_{t} {C}^{Lidar} {X}_{t} - {M}_{t + 1} {C}^{Lidar} {X}_{t + 1} )}^{2}} & ( 6 )\end{matrix}$$

$$\begin{matrix}LIDAR TO CAMERA & \\ {C}_{Cam}^{Lidar} = ( \begin{matrix}{R}_{Cam}^{Lidar} & {T}_{Cam}^{Lidar} \\ 0 & 1\end{matrix} ) & ( 7 )\end{matrix}$$

$$\begin{matrix}Optimization & \\ \{ {M}_{t} {C}_{Cam}^{Lidar} {X}_{t}^{Lidar} \vert t ∈ \{ 1 , … , N \} \} = \{ {M}_{t} {X}_{t}^{Cam} \vert t ∈ \{ 1 , … , N \} \} & ( 8 )\end{matrix}$$

$$\begin{matrix}Cost Function & \\ rmse = \sqrt{( \frac{1}{n} ) {\sum }_{1}^{n} {( {M}_{t} {C}_{Cam}^{Lidar} {X}_{t}^{Lidar} - {M}_{t} {X}_{t}^{Cam} )}^{2}} & ( 9 )\end{matrix}$$

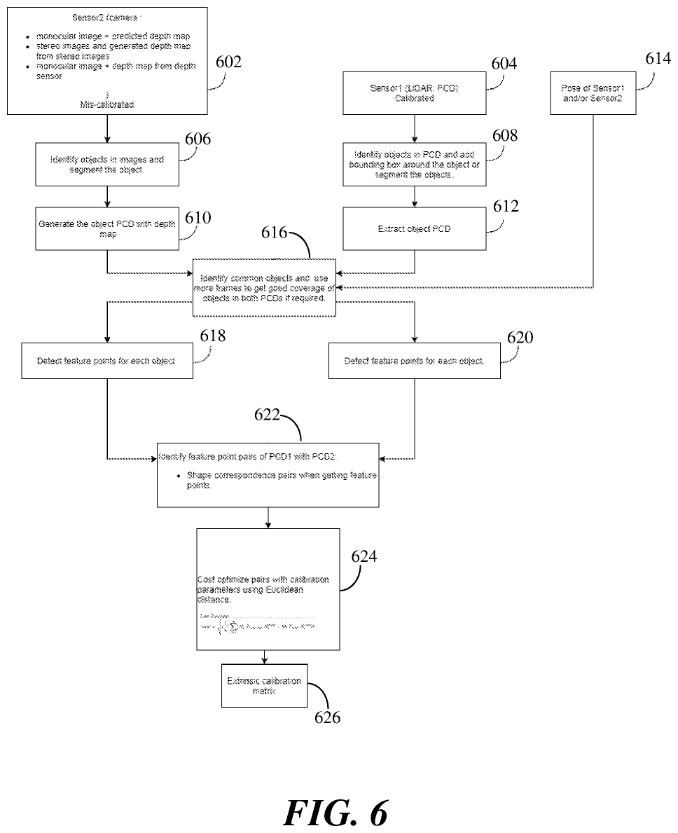

In one system/embodiment, a camera sensor is calibrated using a LIDAR sensor as shown in FIG. 6. For demonstration purposes we are using KITTI dataset for LiDAR and stereo-cameras mounted on top of an AV. 604 and 602 generate sensor output. The monocular/stereo/RGB-D camera 602 is required to be calibrated with the LiDAR 604. The PCD from 604 is used to identify objects of interest, and the objects are segmented, or a bounding box placed around them 608. Then the object PCDs are extracted 612. The objects of interest are identified using the camera image (one of the images in case of stereo images) 602 and segmented 606. The object PCDs 610 are then generated using the camera image (one of the images in case of stereo images) and depth map constructed from the stereo image or predicted using deep learning models or using depth sensor or any other method. One or more common objects 616 are identified with the pose data for LiDAR and/or Camera 614 in PCDs using one or more frames of the sensors. Following which, the feature points 618, 620 are identified using the deep learning techniques such as PointNet, or STN-based approaches, but not limited to, or any similar techniques, to detect the feature points that includes down-sampling methods.

In one embodiment, the feature point extraction method can be used for feature point pairing from two PCDs in the same order the features corresponding to shapes were learnt by the trained deep learning-based model.

In another embodiment, method such as Iterative Closest Point (ICP), but not limited to, or neighbourhood search (KNN, density-based clustering) or any such method to register feature point pairs. Once the pairs 622 are identified the distance between the pairs is minimized by optimizing the calibration parameters 624. The result of this cost optimisation of points 624 that corresponds to the same or similar features in two PCDs determines the extrinsic calibration matrix 626 for Sensor2 with respect to Sensor1, even without the knowledge of the initial extrinsic calibration parameters of Sensor2. Equations 10, 11, 12 give relations for the calibration matrix of Camera to Lidar reference, its optimisation and cost function.

### Camera to Lidar

$${C}_{Lidar}^{Cam} = ( \begin{matrix}{R}_{Lidar}^{Cam} & {T}_{Lidar}^{Cam} \\ 0 & 1\end{matrix} ) \qquad ( 10 )$$

$$\begin{matrix}Optimization & \\ \{ {M}_{t} {C}_{Lidar}^{Cam} {X}_{t}^{Cam} \vert t ∈ \{ 1 , … , N \} \} = \{ {M}_{t} {X}_{t}^{Lidar} \vert t ∈ \{ 1 , … , N \} \} & ( 11 )\end{matrix}$$

$$\begin{matrix}Cost function & \\ rmse = \sqrt{( \frac{1}{n} ) {\sum }_{1}^{n} {( {M}_{t} {C}_{Lidar}^{Cam} {X}_{t}^{Cam} - {M}_{t} {X}_{t}^{Lidar} )}^{2}} & ( 12 )\end{matrix}$$

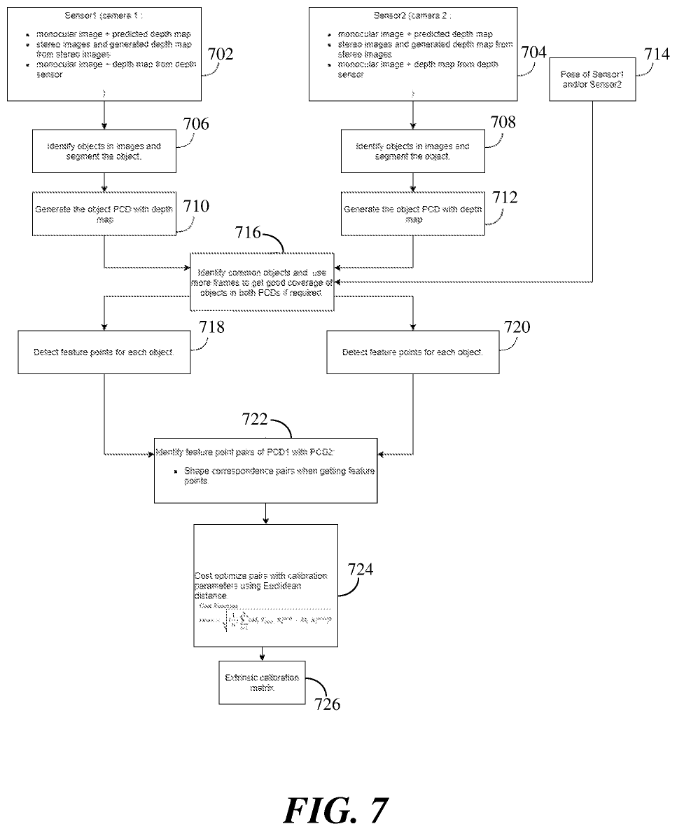

In one system/embodiment, a camera sensor is calibrated using another camera sensor as shown in FIG. 7. For demonstration purposes we are using KITTI dataset for stereo-cameras mounted on top of an AV. 702 and 704 generate sensor output. The monocular/stereo/RGB-D camera 702 is required to be calibrated with another monocular/stereo/RGB-D camera 704. The objects of interest are identified using the camera image (one of the images in case of stereo images) 702, 704 and segmented 706, 708. The object PCDs 710, 712 are then generated using the camera image (one of the images in case of stereo images) and depth map constructed from the stereo image or predicted using deep learning models or using depth sensor or any other method. One or more common objects 716 are identified with the pose data for Camera1 and/or Camera2 714 in the object PCDs using one or more frames of the sensors. Following which, the feature points 718, 720 are identified using the deep learning techniques such as PointNet, or STN-based approaches, but not limited to, or any similar techniques to detect the feature points.

In one embodiment, the feature point extraction method can be used for feature point pairing from two PCDs in the same order the features corresponding to shapes were learnt by the trained deep learning-based model.

In another embodiment, method such as Iterative Closest Point (ICP), but not limited to, or neighbourhood search (KNN, density-based clustering) or any such method to register feature point pairs. Once the pairs 722 are identified the distance between the pairs is minimized by optimizing the calibration parameters 724. The result of this cost optimisation of points 724 that corresponds to the same or similar features in two PCDs determines the extrinsic calibration matrix 726 for Sensor1 for with respect to Sensor2, even without the knowledge of the initial extrinsic calibration parameters of Sensor1. Equations 13, 14, 15 give relations for the calibration matrix of Camera0 to Camera2 reference, its optimisation and cost function.

### Camera to Camera

$${C}_{Cam 2}^{Cam 0} = ( \begin{matrix}{R}_{Cam 2}^{Cam 0} & {T}_{Cam 2}^{Cam 0} \\ 0 & 1\end{matrix} ) \qquad ( 13 )$$

$$\begin{matrix}Optimization & \\ \{ {M}_{t} {C}_{Cam 2}^{Cam 0} {X}_{t}^{Cam 0} \vert t ∈ \{ 1 , … , N \} \} = \{ {M}_{t} {X}_{t}^{Cam 2} \vert t ∈ \{ 1 , … , N \} \} & ( 14 )\end{matrix}$$

$$\begin{matrix}Cost function & \\ rmse = \sqrt{( \frac{1}{n} ) {\sum }_{1}^{n} {( {M}_{t} {C}_{Cam 2}^{Cam 0} {X}_{t}^{Cam 0} - {M}_{t} {X}_{t}^{Cam 2} )}^{2}} & ( 15 )\end{matrix}$$

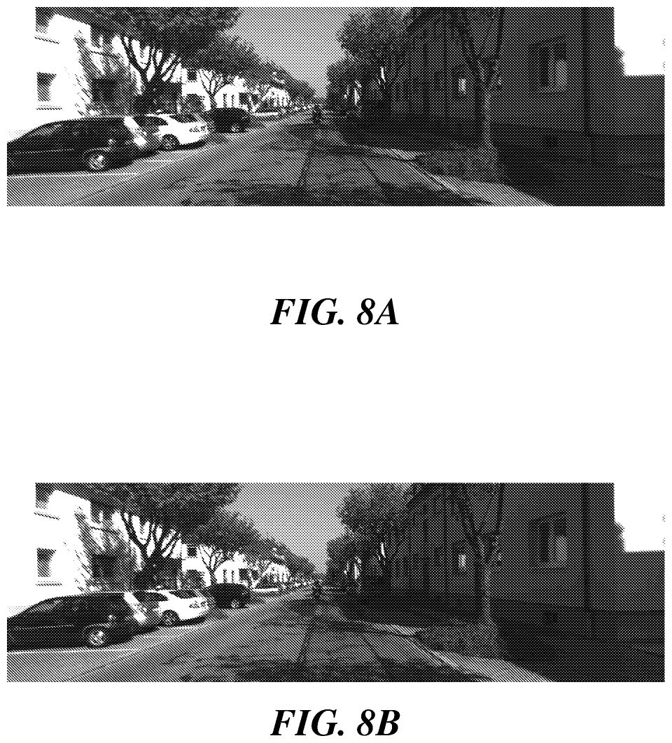

FIG. 8 shows specimen frames from Camera0 of KITTI dataset which are used for validation purposes.

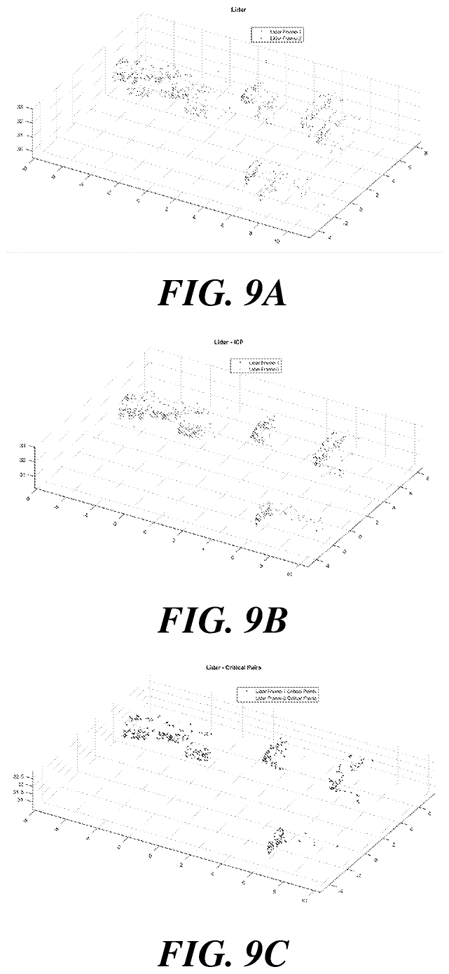

FIG. 9a shows two feature points of consecutive frames of LiDAR visualizing common objects with feature points. FIG. 9b shows registered feature points between two PCDs. FIG. 9c shows feature pairs without outlier features.

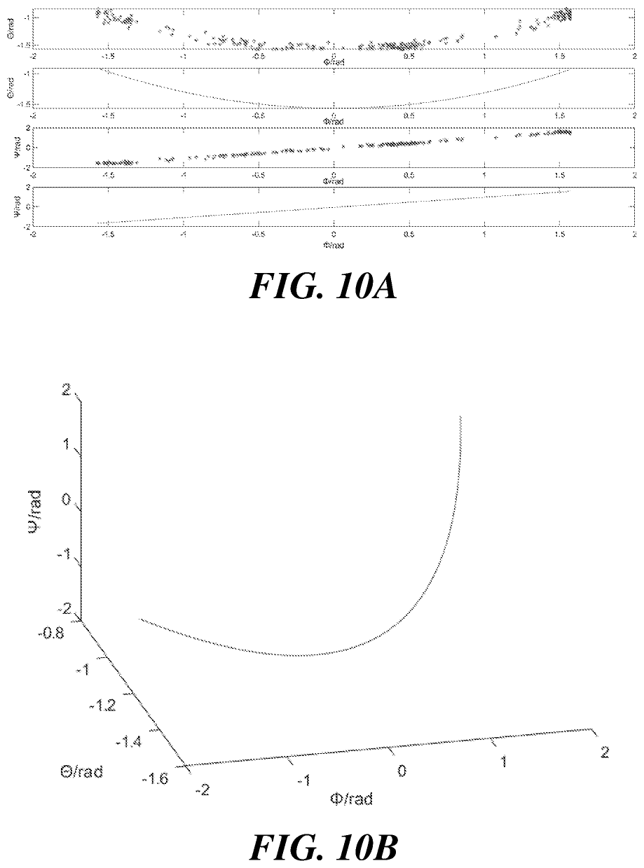

FIG. 10a shows 2D curve fitting of LiDAR calibration with respect to each rotation axis of the AV frame. FIG. 10b shows 3D curve fitting of LiDAR calibration with respect to roll (Φ), pitch (Θ), yaw (ψ) of the AV frame.

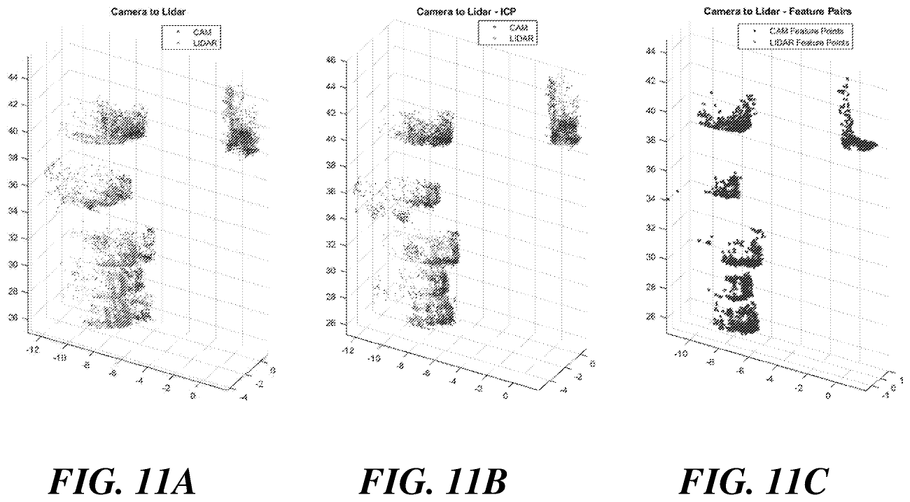

FIG. 11a shows two feature points of LiDAR and Camera frames with common objects. FIG. 11b shows registered feature points between these two PCDs. The feature points from LiDAR are mapped to their calibrated Camera counterparts applying iterative approach searching for closest points. FIG. 11c shows feature pairs without outlier features.

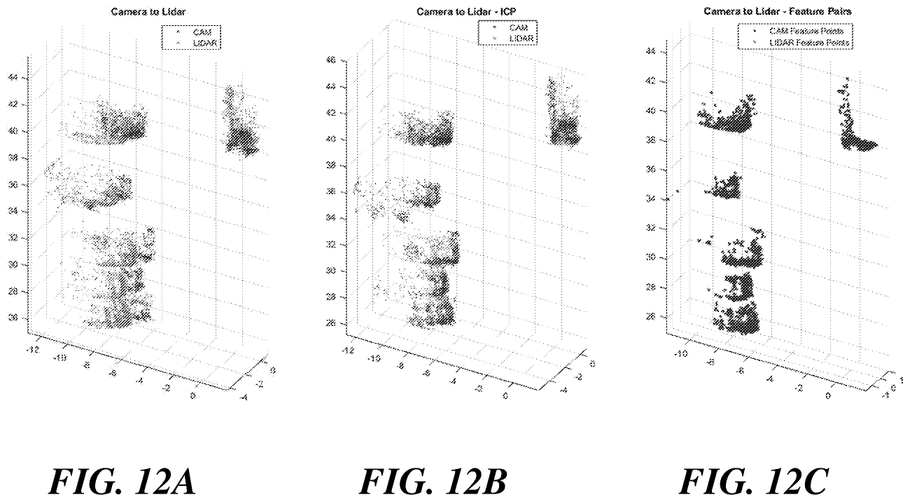

FIG. 12a shows two feature points of Camera and LiDAR frames with common objects. FIG. 12b shows registered feature points between these two PCDs. The feature points from Camera are mapped to their calibrated LiDAR counterparts applying iterative approach searching for closest points. FIG. 12c shows feature pairs without outlier features.

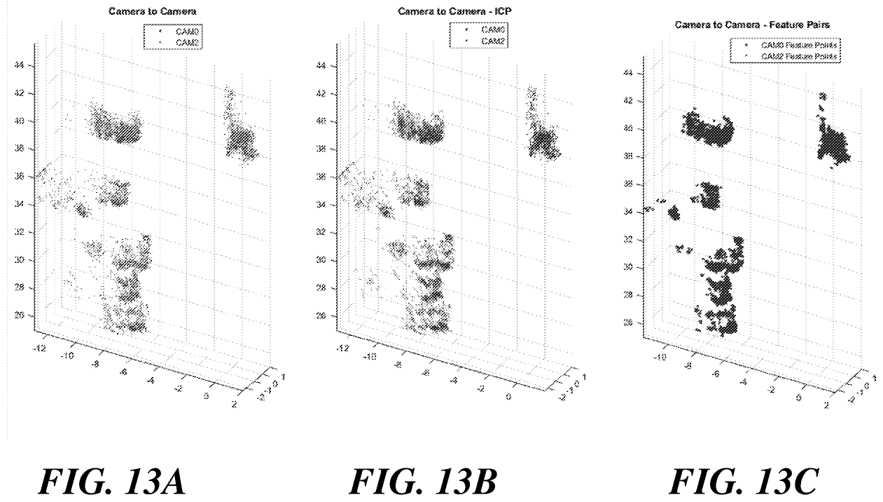

FIG. 13a shows two feature points of Camera0 and Camera2 frames with common objects. FIG. 13b shows registered feature points between these two PCDs. The feature points from Camera0 are mapped to their calibrated Camera2 counterparts applying iterative approach searching for closest points. FIG. 13c shows feature pairs without outlier features.

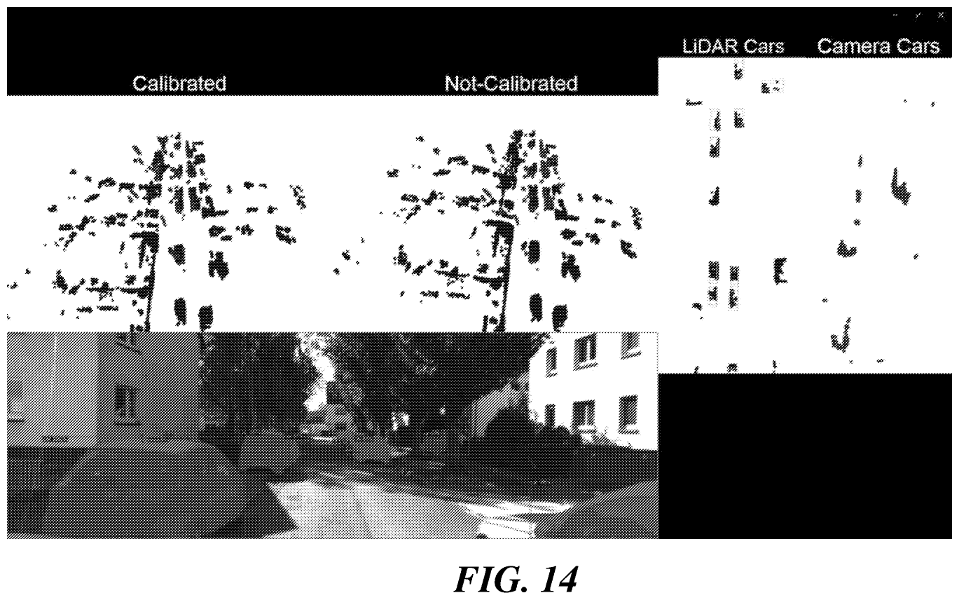

FIG. 14 shows a screenshot result of a demo based on KITTI dataset which shows a residential neighbourhood with static and dynamic objects such as cars, bikes, pedestrian etc. The results show objects (cars) detected in both the sensors and before and after calibration.

Table 1 tabulates results of three embodiments [C_{Cam}^{Lidar}, C_{Lidar}^{Cam}, C_{Cam}^{Cam}] described above in comparison with the ground truth (GT) values taken from KITTI dataset.

TABLE 1

| | | ROTATIION | | | TRANSLATION | | | AVG ERROR | |
|---|---|---|---|---|---|---|---|---|---|
| | | (DEGREE) | | | (CM) | | | ROTATION | TRANSLATION |
| Cₛₑₙₛₒᵣ₂^{sensor1} | | Φ | Θ | Ψ | X | Y | Z | (DEGREE) | (CM) |
| C_{Cam}^{Lidar} | Ground Truth | 69.257 | −69.785 | 68.726 | −1.198 | −5.404 | −29.220 | | |
| | Calibration | | | | | | | | |
| | Invention | 70.225 | −69.634 | 68.875 | 10.039 | 5.276 | −31.589 | | |
| | Error | 0.968 | 0.151 | 0.149 | 11.238 | 10.680 | 2.369 | 0.423 | 8.096 |
| C_{Lidar}^{Cam} | Ground Truth | −69.257 | 69.785 | −68.726 | 29.180 | −1.141 | −5.624 | | |
| | Calibration | | | | | | | | |
| | Invention | −70.319 | 69.787 | −68.824 | 31.860 | 11.866 | 7.736 | | |
| C_{Cam}^{Cam} | Error | 1.062 | 0.002 | 0.098 | 2.679 | 13.007 | 13.360 | 0.388 | 9.682 |
| | Ground Truth | 0.000 | 0.000 | 0.000 | 6.313 | 0.000 | 0.000 | | |
| | Calibration | | | | | | | | |
| | Invention | 0.003 | 0.003 | 0.006 | −0.500 | 0.283 | −0.544 | | |
| | Error | 0.003 | 0.003 | 0.006 | 6.813 | 0.283 | 0.544 | 0.004 | 2.547 |

### LiDAR to RGB-D Camera

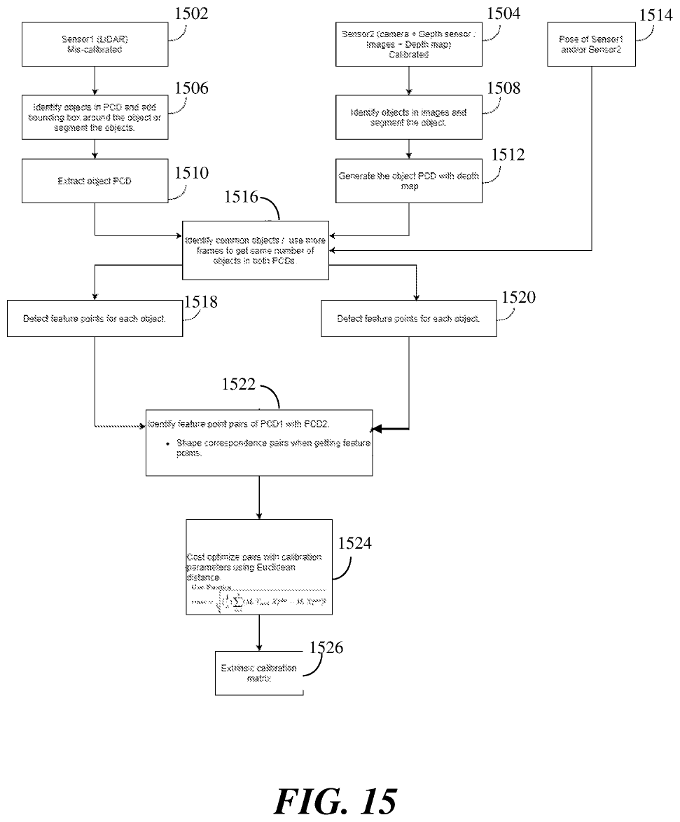

In one system embodiment, a LiDAR sensor is calibrated using a depth camera sensor as shown in FIGS. 15. 1502 and 1504 generate sensor output. The LiDAR 1502 is required to be calibrated with monocular camera associated with a depth sensor 1504. The PCD from 1502 is used to identify objects of interest, and the objects are segmented and/or a bounding box around the objects 1506. Then the objects are extracted 1510. The objects of interest are identified using the camera image 1504 and segmented 1508. The object PCDs 1512 are then generated using the camera image and depth map from depth sensor. One or more common objects 1516 are identified with the pose data for LiDAR and/or Camera 1514 in the object PCDs using one or more frames of the sensors. Following which, the feature points 1518, 1520 are identified using the deep learning techniques such as PointNet, or STN-based approaches, but not limited to any similar techniques or any other approaches to generate the feature points that includes down-sampling methods.

In one embodiment, the feature point extraction method can be used for feature point pairing from two PCDs in the same order the features corresponding to shapes were learnt by the trained deep learning-based model.

In another embodiment, method such as Iterative Closest Point (ICP), but not limited to, or neighbourhood search (KNN, density-based clustering) or any such method to register feature point pairs. Once the pairs 1522 are identified the distance between the pairs is minimized by optimizing the calibration parameters 1524. The result of this cost optimisation of points 1524 that corresponds to the same or similar features in two PCDs determines the extrinsic calibration matrix 1526 for Sensor1 for with respect to Sensor2, even without the knowledge of the initial extrinsic calibration parameters of Sensor1. Equations 7, 8, 9 give relations for the calibration matrix of Lidar to RGB-D Camera reference, its optimisation and cost function.

In one embodiment, if LiDAR axes are not oriented to the AV reference or Inertial Measurement Unit (IMU), an intermediate step(s) can be performed to first align the axes before proceeding to the method described in FIG. 2. This provides an initial starting point for the ICP point registration algorithm. If the feature points and the feature pairs are obtained directly from the deep learning based-architecture, this operation is not needed since the feature pairs are already obtained as part of the shape correspondence provided by the deep learning-based method. The result of the LiDAR to Camera or Camera to LiDAR can be feed iteratively into the ICP technique to improve the calibration results. Equations 4, 5, 6 give relations for the calibration matrix of Lidar to AV reference, its optimisation and cost function.

### RGB-D Camera to LiDAR

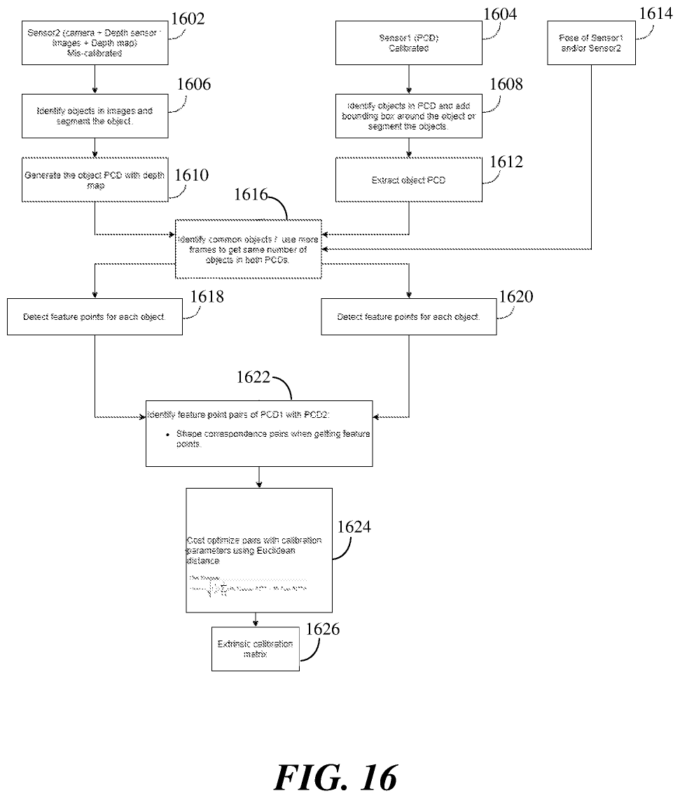

In one system embodiment, a depth camera sensor is calibrated using a LiDAR sensor as shown in FIGS. 16. 1604 and 1602 generate sensor output. The camera 1602 is required to be calibrated with the LiDAR 1604. The PCD from 1604 is used to identify objects of interest, and the objects are segmented or a bounding box around the objects 1608. Then the objects are extracted 1612. The objects of interest are identified using the camera image 1602 and segmented 1606. The object PCDs 1610 are then generated using the camera image and depth map from depth sensor. One or more common objects 1616 are identified with the pose data for LiDAR and/or Camera 1614 in the object PCDs using one or more frames of the sensors. Following which, the feature points 1618, 1620 are identified using the deep learning techniques such as PointNet, or STN-based approaches, but not limited to any similar techniques or any other approaches to generate the feature points that includes down-sampling methods.

In one embodiment, the feature point extraction method can be used for feature point pairing from two PCDs in the same order the features corresponding to shapes were learnt by the trained deep learning-based model.

In another embodiment, method such as Iterative Closest Point (ICP), but not limited to, or neighbourhood search (KNN, density-based clustering) or any such method to register feature point pairs. Once the pairs 1622 are identified the distance between the pairs is minimized by optimizing the calibration parameters 1624. The result of this cost optimisation of points 1624 that corresponds to the same or similar features in two PCDs determines the extrinsic calibration matrix 1626 for Sensor2 for with respect to Sensor1, even without the knowledge of the initial extrinsic calibration parameters of Sensor2. Equations 10, 11, 12 give relations for the calibration matrix of RGB-D Camera to Lidar reference, its optimisation and cost function.

### RGB-D Camera to RGB-D Camera

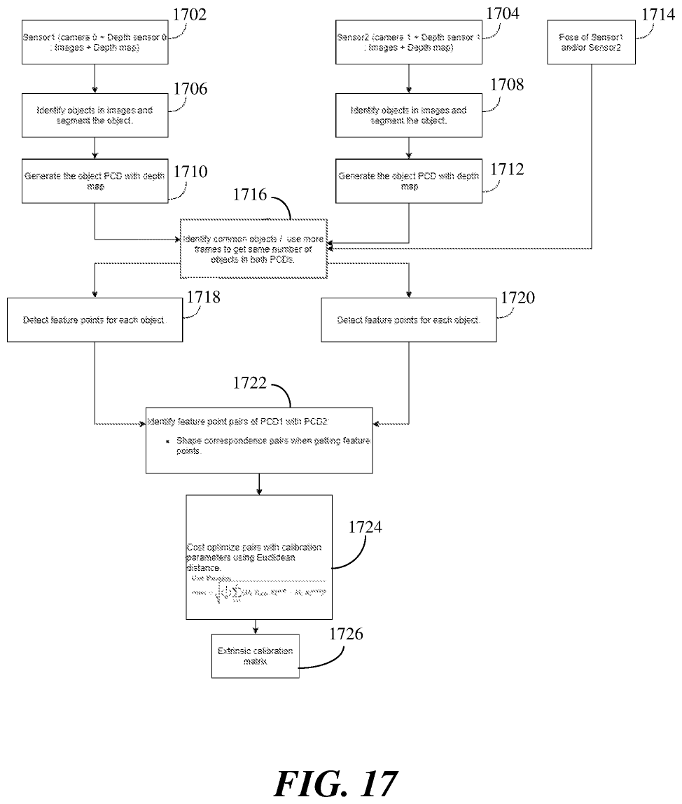

In one system embodiment, a camera sensor is calibrated using another sensor as shown in FIG. 17. For demonstration purposes we are using a miniaturised vehicle setup with RGB-D cameras mounted on top of a miniature vehicle. 1702 and 1704 generate sensor output. The RGB-D camera 1702 is required to be calibrated with another RGB-D camera 1704. The objects of interest are identified using the camera image 1702 and 1704 and segmented 1706, 1708. The object PCDs 1710, 1712 are then generated using the camera image and depth map from depth sensor. One or more common objects 1716 are identified with the pose data for Camera0 and/or Camera1 1714 in the object PCDs using one or more frames of the sensors. Following which, the feature points 1718, 1720 are identified using the deep learning techniques such as PointNet, or STN-based approaches, but not limited to any similar techniques or any other approaches to generate the feature points that includes down-sampling methods.

In one embodiment, the feature point extraction method can be used for feature point pairing from two PCDs in the same order the features corresponding to shapes were learnt by the trained deep learning-based model.

In another embodiment, method such as Iterative Closest Point (ICP), but not limited to, or neighbourhood search (KNN, density-based clustering) or any such method to register feature point pairs. Once the pairs 804 are identified the distance between the pairs is minimized by optimizing the calibration parameters 1724. The result of this cost optimisation of points 1724 that corresponds to the same or similar features in two PCDs determines the extrinsic calibration matrix 1726 for Sensor1 for with respect to Sensor2, even without the knowledge of the initial extrinsic calibration parameters of Sensor1. Equations 13, 14, 15 give relations for the calibration matrix of RGB-D Camera0 to RGB-D Camera2 reference, its optimisation and cost function.

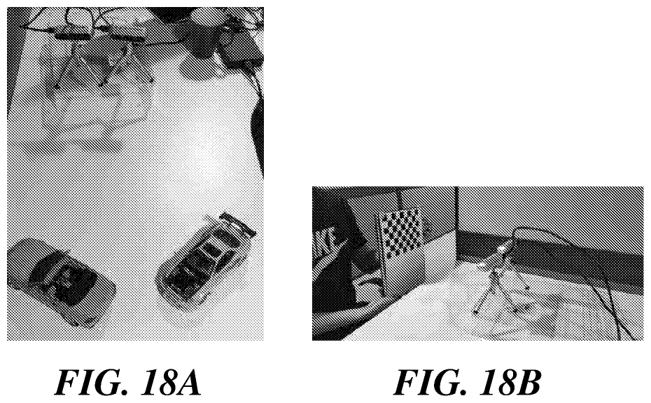

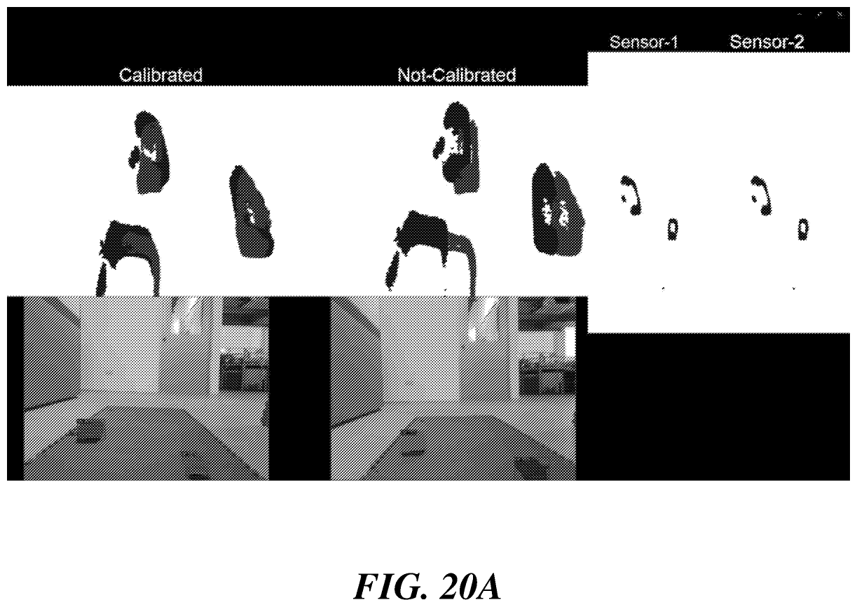

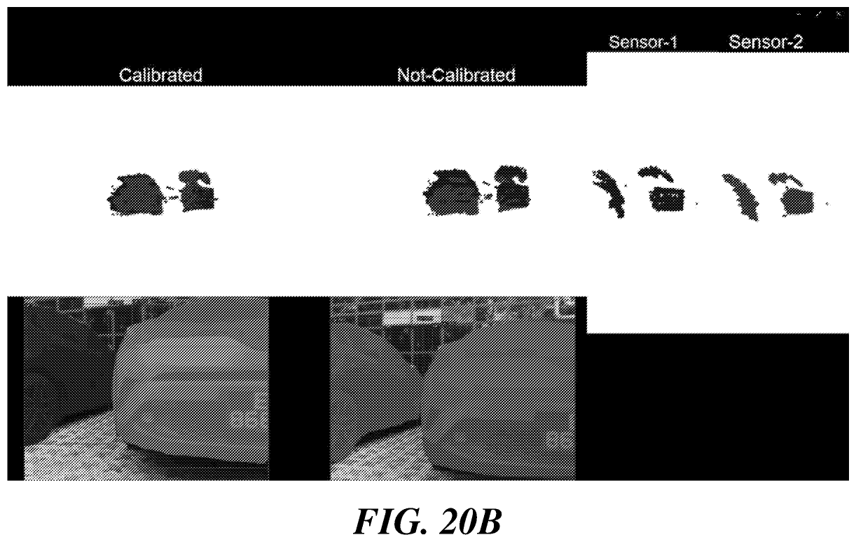

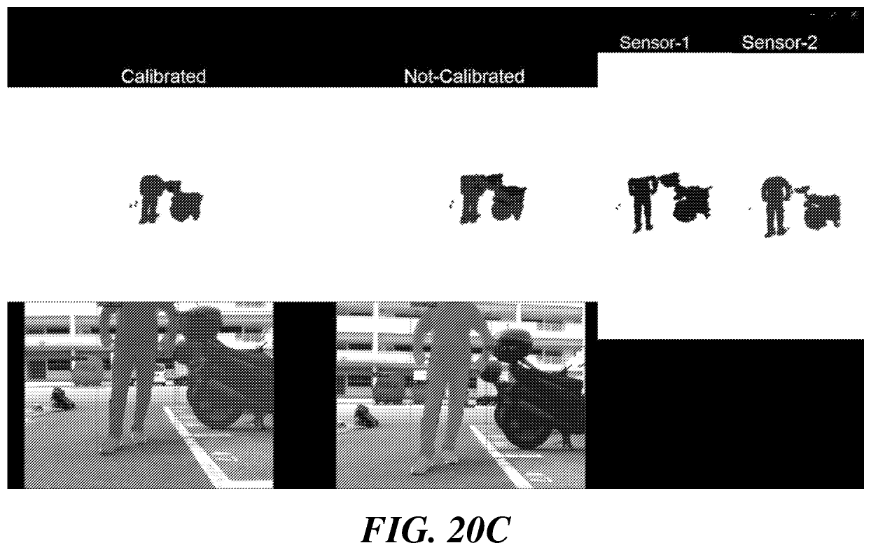

The method is tested on both indoor and outdoor datasets using data captured with two Intel RealSense cameras (D435i). The indoor dataset consists of miniaturised cars as shown in FIG. 18a and FIG. 20a. FIG. 18a shows the setup to record the scene using intel stereo cameras (D435i). The pose from both the RGB-D cameras is identified using depth maps and SLAM to perform the calibration. FIG. 18b shows the ground truth measurements taken using a target-based calibration approach with a checkerboard to validate our calibration results. The PCDs of the objects are generated by detecting the object masks and the depth information. Then the respective sensor's object PCDs are transformed into world coordinates, registered and cost optimized to get the calibration matrix.

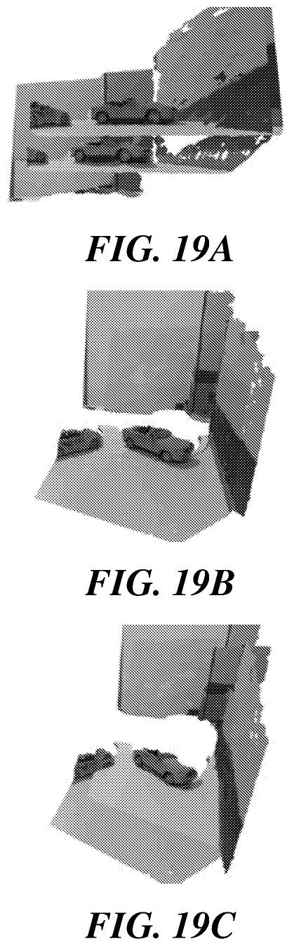

FIG. 19 shows the 3D reconstruction of the scene with depth and RGB data. FIG. 19a shows the uncalibrated reconstruction of the scene from two cameras. FIG. 19b shows results after calibration with ground truth values obtained from target-based approach. FIG. 19c shows results after applying our calibration approach. We get an error percentage of less than 0.17% (absolute value 0.63-degree, degree/360) in rotation and 0.61% (absolute value 0.61 cm, per meter) in translation with respect to ground truth. The rotational and translational errors are mentioned in Table 2.

TABLE 2

| | ROTATIONAL ERRORS | | | TRANSLATIONAL ERRORS | | |
|---|---|---|---|---|---|---|
| | X | Y | Z | X | Y | Z |
| | degree | | | cm | | |
| CURIUM | 0.55 | 0.30 | 0.63 | 0.30 | 0.35 | 0.61 |

FIG. 20 shows a screenshot of demos for RGB-D Camera to RGB-D Camera in both indoor and outdoor setting. FIG. 20a shows a miniaturised vehicle setup. FIG. 20b shows visualisation results based on real cars in a parking lot. FIG. 20c shows multiple static and dynamic objects such as vehicles, motorbikes and pedestrians.

### RADAR To LiDAR

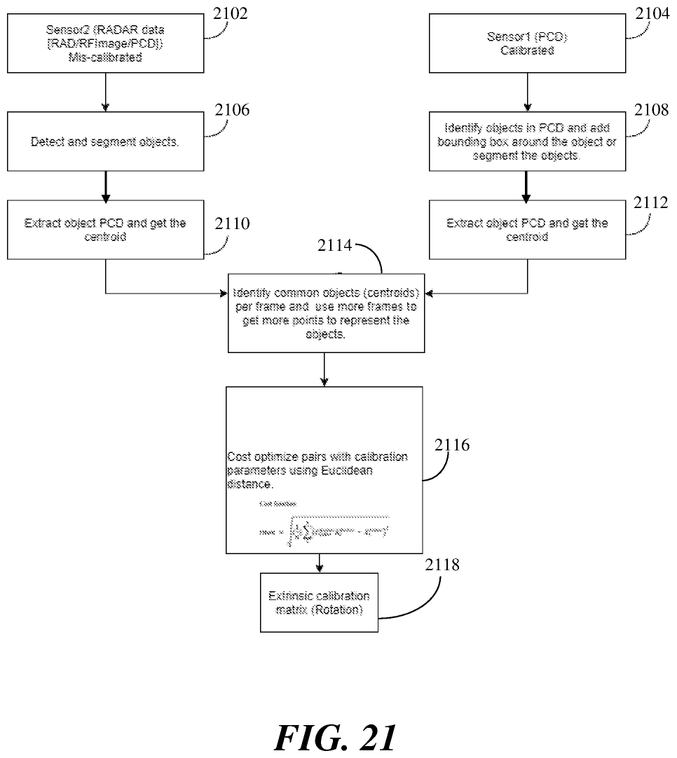

In one system embodiment, a RADAR sensor is calibrated using a LiDAR sensor as shown in FIG. 21. For demonstration purposes, we are using NuScenes dataset for LiDAR and radar mounted on an AV. 2104 and 2102 generate sensor outputs. The RADAR 2102 is required to be calibrated with the LiDAR 2104. The PCD from 2104 is used to detect objects of interest and segment them 2108. 2102 is the RADAR sensor data used to identify objects of interest and segment them 2106. Following which the object PCDs are extracted, and the centroid of the objects are computed 2110, 2112. One or more common objects per frame 2114 are identified using one or more frames of the sensors. Note that here the pairs are identified per frame (one frame from RADAR and an equivalent frame from LiDAR). This step eliminates the requirement of the sensor pose data as the calibration will be done considering the RADAR object points in RADAR coordinate system and LiDAR object points in LiDAR coordinate system, instead of transforming both points in the world coordinate system.

In one embodiment, the feature point extraction method can be used for feature point pairing from two PCDs in the same order the features corresponding to shapes were learnt by the trained deep learning-based model.

In another embodiment, method such as Iterative Closest Point (ICP), but not limited to, or neighbourhood search (KNN, density-based clustering) or any such method to register feature point pairs. Once the pairs 2114 are identified the distance between the pairs is minimized by optimizing the combinations of calibration parameters 2116. The result of this cost optimisation of points 2116 that corresponds to the same or similar features in two sets of centroids 2116 determines the extrinsic calibration matrix 2118 for Sensor2 for with respect to Sensor1, even without the knowledge of the initial extrinsic calibration parameters of Sensor2. Equations 16, 17, 18 give relations for the calibration matrix of RADAR to Lidar reference, its optimisation and cost function.

In another embodiment, provided initial translations are given, the calibration parameters corresponding to rotation alone can be identified.

$${C}_{Lidar}^{Radar} = ( \begin{matrix}{R}_{Lidar}^{Radar} & {T}_{Lidar}^{Radar} \\ 0 & 1\end{matrix} ) \qquad ( 16 )$$

$$\begin{matrix}Optimization & \\ \{ {C}_{Lidar}^{Radar} {X}_{t}^{Radar} \vert t ∈ \{ 1 , … , N \} \} = \{ {X}_{t}^{Lidar} \vert t ∈ \{ 1 , … , N \} \} & ( 17 )\end{matrix}$$

$$\begin{matrix}Cost function & \\ rmse = \sqrt{( \frac{1}{n} ) {\sum }_{1}^{n} {( {C}_{Lidar}^{Radar} {X}_{t}^{Radar} - {X}_{t}^{Lidar} )}^{2}} & ( 18 )\end{matrix}$$

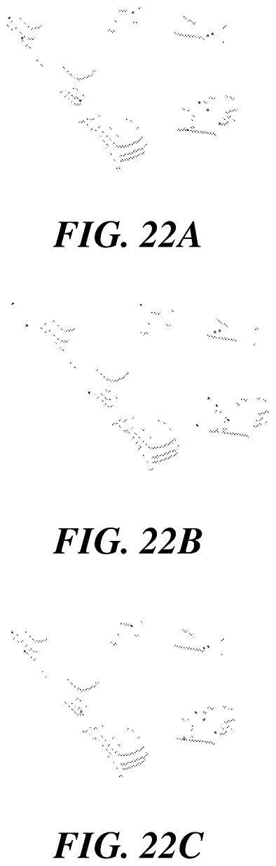

FIG. 22 shows the calibration of RADAR with respect to LiDAR on publicly available NuScenes dataset. FIG. 22a shows the LiDAR (green) and RADAR (red) with ground truth calibration applied. FIG. 22b shows the falsified RADAR PCD superimposed on LiDAR data. FIG. 22c shows after our calibration method applied only optimizing the rotation and with prior translation applied. Table 3 shows the rotational errors in comparison with the ground truth values.

TABLE 3
ROTATIONAL ERRORS

| | X | Y | Z |
|---|---|---|---|
| | degree | | |
| ERROR | 0.00 | −0.29 | 0.43 |

### RADAR to Monocular Camera

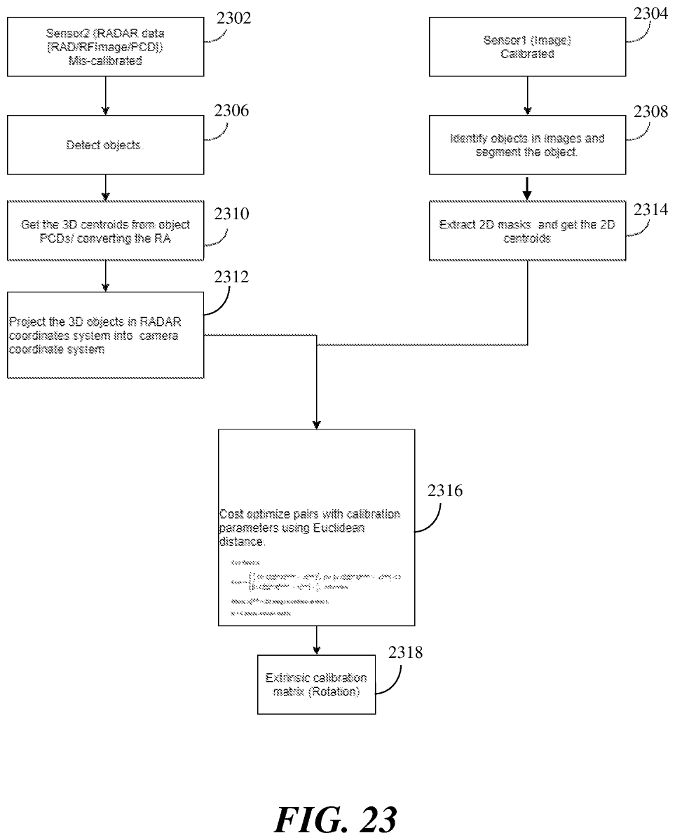

In one system embodiment, a RADAR sensor is calibrated using a camera sensor as shown in FIG. 23. For demonstration purposes publicly available CARRADA dataset for monocular camera and radar mounted on an AV is used. The RADAR 2302 is required to be calibrated with monocular camera 2304. The RADAR sensor data such as RAD/RF image/PCD from 2302 is used to identify objects of interest 2306 and the 3D centroids are obtained from object PCDs or converting the Range Angle information 2310. The 3D object points are then projected on to the image coordinates 2312. The image 2304 is generated using the monocular camera, and then used to identify objects of interest and mask around the object 2308. The masks are extracted and the 2D object centroids are computed and undistorted 2314. Following which, the distance between the radar projected points and the corresponding image object centroids are minimized by optimizing the calibration parameters 2316. The result of this cost optimisation of points 2316 that corresponds to the same or similar features in two points determines the extrinsic calibration matrix 2318 for Sensor1 for with respect to Sensor2, even without the knowledge of the initial extrinsic calibration parameters of Sensor1. Equations 19, 20, 21 give relations for the calibration matrix of RADAR to Camera reference, its optimisation and cost function.

In another embodiment, provided initial translations are given, the calibration parameters corresponding to rotation alone can be identified.

$${C}_{Cam}^{Radar} = ( \begin{matrix}{R}_{Cam}^{Radar} & {T}_{Cam}^{Radar} \\ 0 & 1\end{matrix} ) \qquad ( 19 )$$

$$\begin{matrix}Optimization & \\ \{ Ic {C}_{Cam}^{Radar} {X}_{t}^{Radar} \vert t ∈ \{ 1 , … , N \} \} = \{ {x}_{t}^{Cam} \vert t ∈ \{ 1 , … , N \} \} & ( 20 )\end{matrix}$$

$$\begin{matrix}Cost function & \\ Loss = \{ \begin{matrix}\frac{1}{2} {( Ic {C}_{Cam}^{Radar} {X}_{t}^{Radar} - {x}_{t}^{Cam} )}^{2} , & for \vert Ic {C}_{Cam}^{Radar} {X}_{t}^{Radar} - {x}_{t}^{Cam} \vert < 1 \\ \vert Ic {C}_{Can}^{Radar} {X}_{t}^{Radar} - {x}_{t}^{Cam} \vert - \frac{1}{2} , & otherwise\end{matrix} & ( 21 )\end{matrix}$$

$$Where , {x}_{t}^{Cam} = 2 D image cooridinate at time t ,$$

$$Ic = Camera intrinsic matrix$$

RADAR to Camera with Depth

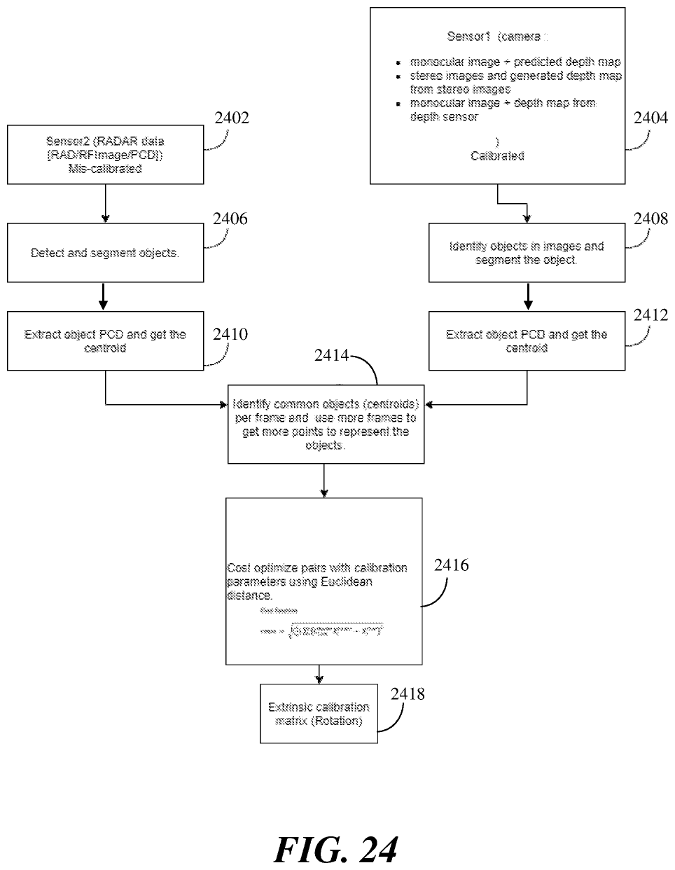

In one system embodiment, a RADAR sensor is calibrated using a Monocular/stereo/RGB-D sensor as shown in FIGS. 24. 2404 and 2402 generate sensor outputs. The RADAR 2402 is required to be calibrated with the monocular/stereo/RGB-D 2404. The objects of interest are identified using the camera image (one of the images in case of stereo images) 2404 and segmented 2408. The object PCDs 2412 are then generated using the camera image (one of the images in case of stereo images) and depth map constructed from the stereo image or predicted using deep learning models or using depth sensor or any other method. 2402 is the RADAR sensor data used to identify objects of interest and segment them 2406. Following which the object PCDs are extracted, and the centroid of the objects are computed 2410. One or more common objects per frame 2414 are identified using one or more frames of the sensors. Note that here the pairs are identified per frame (one frame from RADAR and an equivalent frame from camera). This step eliminates the requirement of the sensor pose data as the calibration will be done considering the RADAR object points in RADAR coordinate system and Camera object points in Camera coordinate system, instead of transforming both points in the world coordinate system.

In one embodiment, the feature point extraction method can be used for feature point pairing from two PCDs in the same order the features corresponding to shapes were learnt by the trained deep learning-based model.

In another embodiment, method such as Iterative Closest Point (ICP), but not limited to, or neighbourhood search (KNN, density-based clustering) or any such method to register feature point pairs (centroids). Once the pairs 2414 are identified the distance between the pairs are minimized by optimizing the combinations of calibration parameters 2416. The result of this cost optimisation of points 2416 that corresponds to the same or similar features in two sets of centroids 2416 determines the extrinsic calibration matrix 2418 for Sensor2 for with respect to Sensor1, even without the knowledge of the initial extrinsic calibration parameters of Sensor2. Equations 16, 17, 18 give relations for the calibration matrix of RADAR to Lidar reference, its optimisation and cost function.

In another embodiment, provided initial translations are given, the calibration parameters corresponding to rotation alone can be identified.

$${C}_{Cam}^{Radar} = ( \begin{matrix}{R}_{Cam}^{Radar} & {T}_{Cam}^{Radar} \\ 0 & 1\end{matrix} ) \qquad ( 22 )$$

$$\begin{matrix}Optimization & \\ \{ {C}_{Cam}^{Radar} {X}_{t}^{Radar} \vert t ∈ \{ 1 , … , N \} \} = \{ {X}_{t}^{Cam} \vert t ∈ \{ 1 , … , N \} \} & ( 23 )\end{matrix}$$

$$\begin{matrix}Cost function & \\ rmse = \sqrt{( \frac{1}{n} ) {\sum }_{1}^{n} {( {C}_{Cam}^{Radar} {X}_{t}^{Radar} - {X}_{t}^{Cam} )}^{2}} & ( 24 )\end{matrix}$$

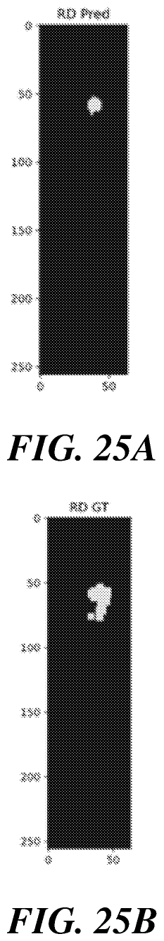

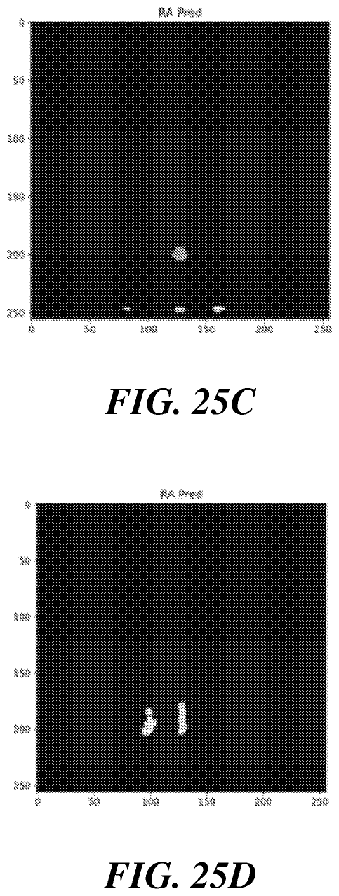

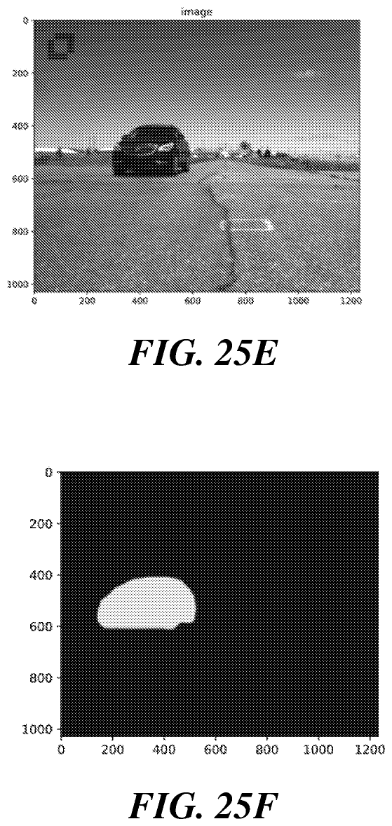

FIG. 25(a-d) shows the RADAR object detection and segmentation. Using Range and Azimuth angle we can project the points in the 3D coordinates. FIG. 25(e-f) shows the image and mask segmentation of the object (car).

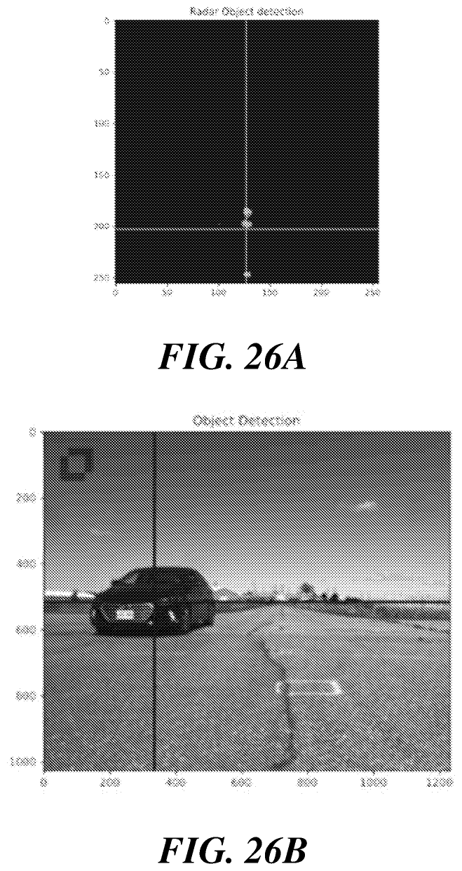

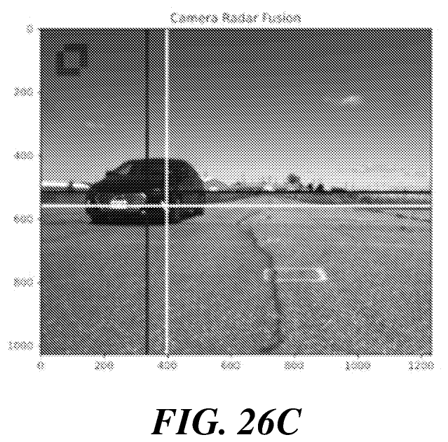

FIG. 26a shows the result of the RADAR object detection. FIG. 26b shows the image with the centroid of the car. FIG. 26c shows the calibrated result of RADAR object centroid with the Camera.

ROTATIONAL ERRORS

| | X | Y | Z |
|---|---|---|---|
| | degree | | |
| ERROR | 5.43 | −3.32 | 2.33 |

In another embodiment, an Ultrasonic sensor is calibrated using another sensor capable of generating PCD directly or indirectly, such as camera, LiDAR and/or a Radar.

In another embodiment, any sensor, capable of generating PCD directly or indirectly, is calibrated using another sensor capable of generating PCD directly or indirectly.

In another embodiment, one or more sensors can be used individually or collectively to calibrate one or more mis-calibrated or uncalibrated sensors.

In all the above embodiments, the steps of object identifying and segmentation can be performed individually or collectively as one step or process.

In all the above embodiments, the field of view (FOV) of the sensors may or may not overlap as long as the common object are captured by both the sensor in any of the following frames with at least one common view. For example, if a sensor is placed on a system or systems such that it is capturing from the front direction and another sensor is placed such that it is capturing from the back direction, either the system(s) is moved or an object is moved in such a way that both the sensors capture the same object from different directions and at different times. The above embodiments can still be applied if both the sensor data contain at least one common view of the same object even from different directions.

In all the above embodiments, the sensors may be a part of a common system or a part of multiple systems while calibrating sensors of one system from the other system. For example, if a sensor or a set of sensors is placed on one system and another set of sensors are placed on another system, the sensors of one system can be calibrated from the sensors of another system as long as both the sets of sensors capture at least one common view from at least one common object.

In all the above embodiments, the pairwise calibration of Sensor1 with respect to Sensor2 can be performed sequentially or parallelly on a single or multiple processors. For example, Sensor1 can be calibrated with respect to Sensor 2, and Sensor3 can be calibrated with respect to Sensor4 at the same time or one after the other. During the pairwise calibration of multiple sensors, one reference sensor can be used to calibrate other sensors at the same or different times. Once the mis-calibrated sensor is calibrated it can now act as a reference sensor for the calibration of other mis-calibrated sensors.

In all the above embodiments, when the calibration is performed on multiple sensors, the steps used in one pairwise calibration can be reused in another pairwise calibration as long as there is at least one common view from at least one common object.

The above-described methods can be applied in many areas such as calibrating sensors of a semi- or fully autonomous vehicle, autonomous robots, drones, ships, planes or any other similar system with sensors. The methods can be used for Static or Dynamic calibration for the system in different settings. Further, there are applications in Internet of Things (IoT) systems and Industry 4.0. The above-described methods may also be applied in medical devices for optical sensors used for areas such as guided surgery, but not limited to, for precise and accurate procedures.

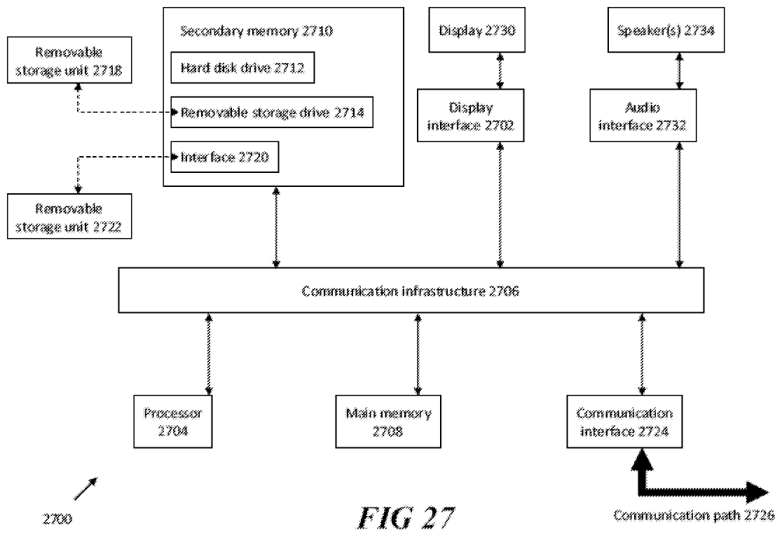

FIG. 27 shows a block diagram of a computer system 2700 for calibration of cooperative sensors as exemplified in FIG. 1B.

The following description of the computer system/computing device 2700 is provided by way of example only and is not intended to be limiting.

As shown in FIG. 27, the example computing device 2700 includes a processor 2704 for executing software routines. Although a single processor is shown for the sake of clarity, the computing device 2700 may also include a multi-processor system. The processor 2704 is connected to a communication infrastructure 2706 for communication with other components of the computing device 2700. The communication infrastructure 2706 may include, for example, a communications bus, cross-bar, or network.

The computing device 2700 further includes a main memory 2708, such as a random access memory (RAM), and a secondary memory 2710. The secondary memory 2710 may include, for example, a hard disk drive 2712 and/or a removable storage drive 2714, which may include a magnetic tape drive, an optical disk drive, or the like. The removable storage drive 2714 reads from and/or writes to a removable storage unit 2718 in a well-known manner. The removable storage unit 2718 may include a magnetic tape, optical disk, or the like, which is read by and written to by removable storage drive 2714. As will be appreciated by persons skilled in the relevant art(s), the removable storage unit 2718 includes a computer readable storage medium having stored therein computer executable program code instructions and/or data.

In an alternative implementation, the secondary memory 2710 may additionally or alternatively include other similar means for allowing computer programs or other instructions to be loaded into the computing device 2700. Such means can include, for example, a removable storage unit 2722 and an interface 2720. Examples of a removable storage unit 2722 and interface 2720 include a removable memory chip (such as an EPROM or PROM) and associated socket, and other removable storage units 2722 and interfaces 2720 which allow software and data to be transferred from the removable storage unit 2722 to the computer system 2700.

The computing device 2700 also includes at least one communication interface 2724. The communication interface 2724 allows software and data to be transferred between computing device 2700 and external devices via a communication path 2726. In various embodiments, the communication interface 2724 permits data to be transferred between the computing device 2700 and a data communication network, such as a public data or private data communication network. The communication interface 2724 may be used to exchange data between different computing devices 2700 which such computing devices 2700 form part an interconnected computer network. Examples of a communication interface 2724 can include a modem, a network interface (such as an Ethernet card), a communication port, an antenna with associated circuitry and the like. The communication interface 2724 may be wired or may be wireless. Software and data transferred via the communication interface 2724 are in the form of signals which can be electronic, electromagnetic, optical or other signals capable of being received by communication interface 2724. These signals are provided to the communication interface via the communication path 2726.

Optionally, the computing device 2700 further includes a display interface 2702 which performs operations for rendering images to an associated display 2730 and an audio interface 2732 for performing operations for playing audio content via associated speaker(s) 2734.

As used herein, the term “computer program product” may refer, in part, to removable storage unit 2718, removable storage unit 2722, a hard disk installed in hard disk drive 2712, or a carrier wave carrying software over communication path 2726 (wireless link or cable) to communication interface 2724. Computer readable storage media refers to any non-transitory tangible storage medium that provides recorded instructions and/or data to the computing device 2700 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 2700. Examples of transitory or non-tangible computer readable transmission media that may also participate in the provision of software, application programs, instructions and/or data to the computing device 2700 include radio or infra-red transmission channels as well as a network connection to another computer or networked device, and the Internet or Intranets including e-mail transmissions and information recorded on Websites and the like.

The computer programs (also called computer program code) are stored in main memory 2708 and/or secondary memory 2710. Computer programs can also be received via the communication interface 2724. Such computer programs, when executed, enable the computing device 2700 to perform one or more features of embodiments discussed herein. In various embodiments, the computer programs, when executed, enable the processor 2704 to perform features of the above-described embodiments. Accordingly, such computer programs represent controllers of the computer system 2700.

Software may be stored in a computer program product and loaded into the computing device 2700 using the removable storage drive 2714, the hard disk drive 2712, or the interface 2720. Alternatively, the computer program product may be downloaded to the computer system 2700 over the communications path 2726. The software, when executed by the processor 2704, causes the computing device 2700 to perform functions of embodiments described herein.

It is to be understood that the embodiment of FIG. 27 is presented merely by way of example. Therefore, in some embodiments one or more features of the computing device 2700 may be omitted. Also, in some embodiments, one or more features of the computing device 2700 may be combined together. Additionally, in some embodiments, one or more features of the computing device 2700 may be split into one or more component parts.

The techniques described in this specification produce one or more technical effects. As mentioned above, embodiments of the present application provide enhanced target-less approaches for calibration of cooperative sensors that can be used both indoors and outdoors.

Furthermore, as described above, the pairwise calibration of Sensor1 with respect to Sensor2 can be performed sequentially or parallelly on a single or multiple processors. During the pairwise calibration of multiple sensors, one reference sensor can be used to calibrate other sensors at the same or different times. Once the mis-calibrated is calibrated, it can advantageously act as a reference sensor for the calibration of other mis-calibrated sensors.

Furthermore, the raw or processed sensor data from any step can be in part or full obtained or derived from other sensors as long as the sensors involved in deriving the data are calibrated with respect to one another. For example, if Sensor1 is calibrated with respect to Sensor2, and when calibrating Sensor3 with respect to Sensor1, Sensor2 data can be used in part or full to support or replace data from Sensor1, and similarly Sensor1 data can be used in part or full to support or replace data from Sensor2 when calibrating Sensor3 with respect to Sensor2.

The above-described methods can be applied in many areas such as calibrating sensors of a semi- or fully autonomous vehicle, autonomous robots, drones, ships, planes or any other similar system with sensors. The methods can be used for Static or Dynamic calibration for the system in different settings. Further, there are applications in Internet of Things (IoT) systems and Industry 4.0. The above-described methods may also be applied in medical devices for optical sensors used for areas such as guided surgery, but not limited to, for precise and accurate procedures.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1-46. (canceled)

47. A method for calibration of cooperative sensors, the method comprising:
obtaining a first set of sensor data for an environment from a first sensor;
obtaining a second set of sensor data for the environment from a second sensor that is cooperative with the first sensor;
identifying one or more objects from the first set of sensor data and the second set of sensor data, wherein the one or more objects comprise one or more dynamic objects;
generating a first point cloud data (PCD) representation for the one or more objects identified from the first set of sensor data;
generating a second point cloud data (PCD) representation for the one or more objects identified from the second set of sensor data;
identifying one or more common objects that are present in both the first PCD representation and the second PCD representation;
identifying feature point pairs for each object in the one or more common objects, wherein each feature point pair of the feature point pairs comprises one or more feature points extracted from the first PCD representation and/or the second PCD representation corresponding to a same or similar feature of the object; and
for each feature point pair of the feature point pairs, minimizing a distance between feature points in the feature point pair so as to form an extrinsic calibration matrix for calibrating the second sensor based on the first sensor.

48. The method according to claim 47, wherein the obtaining of the first set of sensor data comprises obtaining one or more frames of the first sensor, and wherein the obtaining of the second set of sensor data comprises obtaining one or more frames of the second sensor.

49. The method according to claim 47, wherein the first sensor has a first field of view, the second sensor has a second field of view, and the first field of view overlaps with the second field of view.

50. The method according to claim 47, wherein the one or more objects further comprise one or more static objects.

51. The method according to claim 47, further comprising:
identifying the one or more common objects that are present in both the first PCD representation and the second PCD representation using prior knowledge or applying coarse sensor fusion to identify a common field of view for the first sensor and the second sensor, and
projecting the one or more common objects into a frame of reference of the second sensor for calibrating the second sensor based on the first sensor.

52. The method according to claim 47, further comprising:
obtaining a pose data from one of the first sensor and the second sensor, the pose data indicating a pose of the one of the first sensor and the second sensor;
transforming the first PCD representation and the second PCD representation into a common frame of reference based on the pose, wherein the transforming includes applying a pose correction to one of the first sensor and the second sensor that does not provide the pose data; and
identifying the one or more common objects in the common frame of reference.

53. The method according to claim 47, wherein prior to the identifying of one or more common objects that are present in both the first PCD representation and the second PCD representation, the method further comprises:
obtaining a first pose data from the first sensor, the first pose data indicating a first pose of the first sensor;
obtaining a second pose data from the second sensor, the second pose data indicating a second pose of the second sensor;
transforming the first PCD representation and the second PCD representation into a common frame of reference based on the first pose and the second pose; and
identifying the one or more common objects in the common frame of reference.

54. The method according to claim 47, wherein prior to the generating of the first PCD representation for the one or more objects identified from the first set of sensor data, the method comprises:
segmenting the one or more objects from the first set of sensor data and the second set of sensor data based on one or more of the following:
a machine/deep learning approach,
a Computer Vision approach, and
prior object knowledge or position and geometry of the one or more objects.

55. The method according to claim 47, further comprising:
segmenting while identifying the one or more objects from the first set of sensor data and the second set of sensor data based on one or more of the following:
a machine/deep learning approach,
a Computer Vision approach, and
prior object knowledge or position and geometry of the one or more objects.

56. The method according to claim 47, wherein the first sensor or the second sensor is one of the following:
a camera sensor,
a Light Detection and Ranging (LiDAR) sensor,
a Radio Detection and Ranging (RADAR) sensor,
an ultrasonic sensor,
a proximity or distance sensor, and
a range sensor.

57. The method according to claim 47, wherein the feature points are extracted from the first PCD representation and/or the second PCD representation using a deep learning approach, wherein the extracted feature points comprise uniformly sampled representation and/or Centroid representation, and wherein the deep learning approach comprises one of PointNet and STN-based approaches.

58. The method according to claim 47, wherein the identifying of feature point pairs for each object in the one or more common objects is based on one or more of the following:
an Iterative Closest Point (ICP) algorithm,
a k-nearest neighbors (KNN) algorithm, and
a density-based clustering algorithm.

59. A system for calibration of cooperative sensors, the system comprising:
at least one processor; and
a memory including computer program code for execution by the at least one processor, the computer program code instructs the at least one processor to:
obtain a first set of sensor data for an environment from a first sensor;
obtain a second set of sensor data for the environment from a second sensor that is cooperative with the first sensor;
identify one or more objects from the first set of sensor data and the second set of sensor data, wherein the one or more objects comprise one or more dynamic objects;
generate a first point cloud data (PCD) representation for the one or more objects identified from the first set of sensor data;
generate a second point cloud data (PCD) representation for the one or more objects identified from the second set of sensor data;
identify one or more common objects that are present in both the first PCD representation and the second PCD representation;
identify feature point pairs for each object in the one or more common objects, wherein each feature point pair of the feature point pairs comprises one or more feature points extracted from the first PCD representation and/or the second PCD representation corresponding to a same or similar feature of the object; and
for each feature point pair of the feature point pairs, minimize a distance between feature points in the feature point pair so as to form an extrinsic calibration matrix for calibrating the second sensor based on the first sensor.

60. The system according to claim 59, wherein the first set of sensor data comprises one or more frames of the first sensor, and the second set of sensor data comprises one or more frames of the second sensor.

61. The system according to claim 59, wherein the first sensor has a first field of view, the second sensor has a second field of view, and the first field of view overlaps with the second field of view.

62. The system according to claim 59, wherein the one or more objects further comprise one or more static objects.

63. The system according to claim 59, wherein the system is further configured to:
identify the one or more common objects that are present in both the first PCD representation and the second PCD representation using prior knowledge or applying coarse sensor fusion to identify a common field of view for the first sensor and the second sensor, and
project the one or more common objects into a frame of reference of the second sensor for calibrating the second sensor based on the first sensor.

64. The system according to claim 59, wherein the system is further configured to:
obtain a pose data from at least one of the first sensor and the second sensor, the pose data indicating a pose of the at least one of the first sensor and the second sensor;
transform the first PCD representation and the second PCD representation into a common frame of reference based on the pose, wherein the transforming includes applying a pose correction to one of the first sensor and the second sensor that does not provide the pose data; and
identify the one or more common objects in the common frame of reference.

65. The system according to claim 59, wherein prior to the identifying of one or more common objects that are present in both the first PCD representation and the second PCD representation, the system is further configured to:
obtain a first pose data from the first sensor, the first pose data indicating a first pose of the first sensor;
obtain a second pose data from the second sensor, the second pose data indicating a second pose of the second sensor;
transform the first PCD representation and the second PCD representation into a common frame of reference based on the first pose and the second pose; and
identify the one or more common objects in the common frame of reference.

66. The system according to claim 59, wherein prior to the generating of the first PCD representation for the one or more objects identified from the first set of sensor data, the system is configured to:
segment the one or more objects from the first set of sensor data and the second set of sensor data based on one or more of the following:
a machine/deep learning approach,
a Computer Vision approach, and
prior object knowledge or position and geometry of the one or more objects.

67. The system according to claim 59, wherein the system is further configured to:
segment while identify the one or more objects from the first set of sensor data and the second set of sensor data based on one or more of the following:
a machine/deep learning approach,
a Computer Vision approach, and
prior object knowledge or position and geometry of the one or more objects.

68. The system according to claim 59, wherein the first sensor or the second sensor is one of the following:
a camera sensor,
a Light Detection and Ranging (LiDAR) sensor,
a Radio Detection and Ranging (RADAR) sensor,
an ultrasonic sensor,
a proximity or distance sensor, and
a range sensor.

69. The system according to claim 59, wherein the feature points are extracted from the first PCD representation and/or the second PCD representation using a deep learning approach, wherein the extracted feature points comprise uniformly sampled representation and/or Centroid representation, and wherein the deep learning approach comprises one of PointNet and STN-based approaches.

70. The system according to claim 59, wherein during the identifying of feature point pairs for each object in the set of object of interest, the system is configured to identify feature point pairs for each object in the one or more common objects based on one or more of the following:
an Iterative Closest Point (ICP) algorithm,
a k-nearest neighbors (KNN) algorithm, and
a density-based clustering algorithm.

71. The system according to claim 59, wherein the system is one of the following:
a semi-autonomous vehicle,
a fully autonomous vehicle,
an autonomous robot,
a drone,
a ship,
a plane,
an Internet of Things (IoT) system,
an Industry 4.0 system, and
a medical device.

72. A non-transitory computer readable storage medium having instructions encoded thereon that, when executed by a processor, cause the processor to:
obtain a first set of sensor data for an environment from a first sensor;
obtain a second set of sensor data for the environment from a second sensor that is cooperative with the first sensor;
identify one or more objects from the first set of sensor data and the second set of sensor data, wherein the one or more objects comprise one or more dynamic objects;
generate a first point cloud data (PCD) representation for the one or more objects identified from the first set of sensor data;
generate a second point cloud data (PCD) representation for the one or more objects identified from the second set of sensor data;
identify one or more common objects that are present in both the first PCD representation and the second PCD representation;
identify feature point pairs for each object in the one or more common objects, wherein each feature point pair of the feature point pairs comprises one or more feature points extracted from the first PCD representation and/or the second PCD representation corresponding to a same or similar feature of the object; and
for each feature point pair of the feature point pairs, minimize a distance between feature points in the feature point pair so as to form an extrinsic calibration matrix for calibrating the second sensor based on the first sensor.
